(19) United States
(12) Patent Application Publication
(10) Pub. No.: US 2023/0272272 A1
(43) Pub. Date: Aug. 31, 2023

(54) Surface Treatment Of Quantum Dots

(71) Applicant: The Trustees of Columbia University in the city of New York, New York, NY (US)

(72) Inventors: Abraham J Jordan, New York, NY (US); Jonathan S. Owen, New York, NY (US); Rodolphe Valleix, New York, NY (US); Lilian Guillemeny, New York, NY (US)

(21) Appl. No.: 18/160,700

(22) Filed: Jan. 27, 2023

Related U.S. Application Data
(60) Provisional application No. 63/304,418, filed on Jan. 28, 2022.

(51) Int. Cl. C09K 11/02; C09K 11/61; C09K 11/06; B82Y 20/00

(52) U.S. Cl. CPC C09K 11/025; C09K 11/615; C09K 11/06; B82Y 20/00

(57) ABSTRACT

The disclosure provides processes for preparing etched quantum dots comprising Group II-VI and/or III-V elements. The processes include etching Group II-VI or III-V element quantum dots with an organic fluoride agent or ammonium salt and optionally shelling the etched quantum dots. The disclosure also provides processes for generating light from these quantum dots and devices, stains, or labels comprising the quantum dots prepared as described herein.

### CROSS-REFERENCE TO RELATED APPLICATIONS

This application claims the benefit of the priority of U.S. Provisional Patent Application No. 63/304,418, filed Jan. 28, 2022, which is incorporated by reference herein in its entirety.

### GOVERNMENT RIGHTS

This invention was made with government support under Contract No. DE-EE0008716 awarded by the Department of Energy. The government has certain rights in the invention.

### TECHNICAL FIELD

The present disclosure provides, inter alia, processes for preparing etched quantum dots and uses thereof.

### BACKGROUND

Quantum dots (QDs) are particles having a nanometer size and have a wide range of uses. Quantum dots have optical and electronic properties that differ from larger particles. When quantum dots are illuminated by UV light, electrons are be excited to a higher energy state. The excited electron then drops back into the valence band releasing its energy by the emission of light. The efficiency of this process is the quantum yield.

A way to improve the emission spectra of Group III-V quantum dots is by adding HF to the Group III-V cores. HF treatment removes surface traps, thereby boosting the quantum yield. Although useful as an etchant due to its corrosive nature, HF poses many significant safety hazards. In particular, hydrofluoric acid is a powerful contact poison and poisoning readily occurs through exposure of skin or eyes, or when inhaled or swallowed.

As such, there is an unmet need for alternate methods and techniques of improving quantum yield of quantum yields.

### SUMMARY

In some aspects, the disclosure provides processes for preparing etched quantum dots comprising Group III-V elements. The processes include etching Group III-V element quantum dots with an organic fluoride agent and optionally shelling the etched quantum dots.

In other aspects, the disclosure provides processes for generating light from quantum dots comprising Group III-V elements. The processes include etching the quantum dots with organic fluoride agent to form etched quantum dots; applying energy to the etched quantum dots to provide excited quantum dots; and optionally shelling the etched quantum dots.

In some aspects, the disclosure provides processes for preparing etched quantum dots comprising Group II-VI elements. The processes include etching Group II-VI element quantum dots with an organic fluoride agent or ammonium fluoride salt and optionally shelling the etched quantum dots.

In other aspects, the disclosure provides processes for generating light from quantum dots comprising Group II-VI elements. The processes include etching the quantum dots with organic fluoride agent or ammonium fluoride salt to form etched quantum dots; applying energy to the etched quantum dots to provide excited quantum dots; and optionally shelling the etched quantum dots.

In further aspects, the disclosure provides quantum dots prepared according to the processes described herein.

In yet other aspects, the disclosure provides devices, stains, or labels comprising a quantum dot prepared according to the processes described herein.

### BRIEF DESCRIPTION OF THE DRAWINGS

The present application is further understood when read in conjunction with the appended drawings. For the purpose of illustrating the subject matter, exemplary embodiments of the subject matter are shown in these drawings; however, the presently disclosed subject matter is not limited to the specific methods, devices, and systems disclosed. In addition, the drawings are not necessarily drawn to scale. In the drawings:

FIG. 1 is the spectrum for unetched and etched samples of Example 1.

FIG. 2 is the spectrum for unetched and etched samples of Example 2.

FIG. 3 is the spectrum for unetched and etched samples of Example 3.

FIG. 4 is the UV-Vis spectrum of the synthesized InP QDs through the aminophosphine route in Example 4.

FIG. 5 is the ³¹P {¹H} NMR spectrum obtained after 3 hours of etching (3 eq. of benzoyl fluoride, no oleylamine added) of oleylamine-capped InP QDs of Example 13. In this figure, tris(trifluoromethyl)phenyl)phosphine (δ=−6.29 ppm), monobenzoylphosphine (PhCOPH₂-δ=−109.6 ppm) and phosphine (PH₃-δ=−242.3 ppm) are visible on the spectrum.

FIG. 6A is a scheme of the reaction between tris-(trimethylsilyl)phosphine and methanol-d₃ as described in Example 13. FIGS. 6B and 6C are the ¹H and ¹H{³¹P} NMR spectra, respectively, of the crude mixture highlighting the presence of PH₃ and TMS-PH₂.

FIGS. 6D and 6E are the ³¹P and ³¹P{¹H} NMR spectra, respectively, of the crude mixture.

FIG. 7 is the ¹H NMR spectrum comparison between pure oleylbenzamide (lower line—black) and the reaction mixture of Example 13 during etching (upper line—gray) in C₆D₆. In this figure, etching conditions: ratio 1:3:0-3 hours-λ_{exc}=400 nm. ( [symbol] corresponds to PH₃ signal, see FIG. 6).

FIG. 8 is the in situ ³¹P NMR spectra before (lower line—black) and after (upper line—gray) etching in C₆D₆ using 1 eq. of [F]⁻[H₃N—R]⁺, 3 hours of photoexcitation at room temperature, λ_{etching}=427 nm of Example 13.

FIGS. 9 and 10 are plots of the etching percentage and FWHM evolution under different molar ratios of the reagents, InP:benzoyl fluoride:oleylamine (top line=1.3.6; middle line=1:1:2; lower line=1.0.5.1), respectively, for Example 15. It can be seen that the lowest ratio of etchants to molar equivalents of InP produces the least etching percentage and the lowest final full width at half maximum (FWHM) of the luminescence spectral linewidth.

FIGS. 11A and 11B are images from the samples of Example 15. FIG. 11A are STEM-HAADF images under different magnifications for “large” InP QDs before etching. FIG. 11B are STEM-HAADF images of etched InP QDs obtained after the use of InP:benzoyl fluoride:oleylamine=1.3.3 for 3 hours (λ_{exc}=400 nm). In these figures, scale bars are 100 nm.

FIG. 12A are STEM-HAADF images of “large” InP QDs (λₗₛ₋ₗₛ=583 nm-calc. edge length, L=5.8 nm) (scale bar: 50 nm) from Example 15. FIG. 12B are size histograms obtained for the same STEM-HAADF images and L_{STEM}=5.6±0.5 nm and 5.3±0.4 nm are obtained before and after etching, respectively. In these figures, the etching conditions included 1 eq. of oleylNH₃F-3 hours-λ_{exc}=427 nm.

FIG. 13 is powder x-ray diffraction pattern obtained before (upper line—black) and after etching (lower line—gray) as described in Examples 7, 13, and 15. Etching conditions: ratio 1:1:2-3 hours-λ_{exc}=427 nm. The black trace corresponds to the smoothed emission spectrum for starting InP QDs highlighting the trap emission (k>700 nm).

FIGS. 14A to 14D are plots of etching percentage and FWHM evolution under different etching ratios for Example 7, 13 and 15. FIGS. 14B to 14D are snippets from FIG. 14A. The lower line in FIG. 14A corresponds to InF3, the middle line corresponds to after fluorination, and the upper line corresponds to before fluorination.

FIG. 15 is the EDX spectrum taken on InP QDs of Example 13 after surface fluorination. The low intensity of the fluorine signal confirms the conclusion made previously using XPS.

FIGS. 16A and 16B are plots of size-dependent etching percentage evolution upon blue light excitation (427 nm) for Example 14. FIG. 16A is for 1 and 3 eq. of oleylNH₃F and FIG. 16B is for several sub-stoichiometric ratios. In these figures, “Large” and “Small” refer to InP QDs with excitonic transitions at 580 and 540 nm, respectively.

FIGS. 17A and 17B are V-Vis spectra for CdS (FIG. 17A) and ZnSe (FIG. 17B) QDs before (upper line—black) and after (lower line—gray) 3 hours of fluorination (1 eq. of oleylNH₃F) of Example 14.

FIGS. 18A and 18B are XPS survey spectra of CdS QDs before (lower line—black) and after (upper line—gray) surface fluorination as described in Example 14. FIG. 18B is the high resolution spectrum showing the presence of surface fluorine (F is) after the surface fluorination.

FIG. 19 is the EDX spectrum taken on CdS QDs after surface fluorination of Example 14. This analysis confirms the low amount of fluoride left on the surface of the CdS QDs.

FIG. 20 are STEM-HAADF images of CdS QDs before and after surface fluorination using 1 eq. of oleylNH₃F at varying degrees of magnification for Example 14.

FIG. 21 is the UV-Vis and PL spectra of CdSe QDs before (black) and after (gray) surface fluorination as described in Example 14.

FIGS. 22A-22B provides PL and UV-Vis spectra obtained before and after surface fluorination of red-emitting (“large”) QWs (FIG. 22A) and (green-emitting (“small”) QWs (FIG. 22B) as described in Example 12.

FIG. 23 provides STEM-HAADF images of “large” CdS/CdSe/CdS QWs (λₑₘ=625 nm) of Example 12 before and after surface fluorination using 1 eq. of oleylNH₃F at varying degrees of magnification.

FIG. 24 provides STEM-HAADF images of “small” CdS/CdSe/CdS QWs (λₑₘ=520 nm) of Example 12 before and after surface fluorination using 1 eq. of oleylNH₃F at varying degrees of magnification.

FIG. 25 provides STEM-HAADF images of red-emitting InP/ZnS QDs (λₑₘ=625 nm) of Example 9 before and after surface fluorination using 1 eq. of oleylNH₃F at varying degrees of magnification.

FIG. 26 is a plot of evolution of the etching percentage of oleylamine-capped InP QDs of Example 10 for different amines for a 1 eq. of ammonium fluoride (RₓNH₄₋ₓF) under blue-light excitation (λ_{etching}=427 nm).

FIG. 27 is a plot of etching percentage evolution of InP QDs of Example 11 under different sub-stoichiometric conditions.

FIG. 28A is a plot of evolution excitonic wavelength extracted from the UV-Vis spectra using different etchant ratios for Example 11. FIG. 28B is a plot of evolution of the FWHM for the same ratios obtained from the PL spectra (λ_{exc}=400 nm).

FIGS. 29A, 29B, and 29C are UV-Vis spectra showing evolution using different ratios of 1:3:3 (FIG. 29A), 1:6:6 (FIG. 29B) and 1:9:9 (FIG. 29C).

FIGS. 30A and 30B are PL (λ_{exc}=400 nm) spectra evolution of myristate-capped InP QDs (λₗₛ₋ₗₛ=580 nm) of Example 6 under different etching conditions. FIG. 30A uses 1 eq. of OleylNH₃F-0 to 24 hours-λ_{etching}=427 nm and FIG. 30B uses a ratio of 1:3:3-0 to 24 hours-λ_{etching}=427 nm.

FIGS. 31A and 31B are ³¹P and ¹H NMR spectra of the starting myristate-capped InP QDs of Example 6—♥ in FIG. 31A is for tri-(n-butyl)phosphine. FIG. 31C is the ³¹P NMR spectrum of the crude mixture during the first step of the ligand exchange showing the bound and free tributyl phosphine of Example 6—♦ is for tri-(n-butyl)phosphine oxide. FIG. 31D is the ¹H NMR spectrum of the crude mixture of Example 6 during the first step of the ligand exchange showing the bound and free tributyl oleylamine. FIGS. 31E and 31F are the ³¹P and ¹H NMR spectra, respectively, of the exchanged QDs of Example 6 after purification showing the complete exchange of the tributylphosphine.

FIG. 32A is the PL, FIG. 32B is the UV-Vis spectra, and FIG. 32C is the FWHM and emission maximum wavelength evolution during the etching of exchanged InP QDs (1 eq. of OleylNH₃F-λ_{etching}=427 nm) of Example 6. In FIG. 32C, the squares represent the time evolution of the maximum emission wavelength and the circles represent the time evolution of the full-width at half-maximum (FWHM) of the emission peak.

FIG. 33 is the UV-Vis and PL spectra of InP QDs before (black) and after (gray) etching with [F]⁻[H₃N—R]⁺ of Example 13. In this figure, the etching conditions were 1 eq. of [F]⁻[H₃N—R]⁺—three hours of illumination (λₘₐₓ=427 nm). In the inset: InP QDs in toluene under UV excitation (λ_{exc}=365 nm) before (left) and after (right) etching. The photoluminescence fwhm narrows from >50 nm to 42 nm over 3 hours at room temperature under irradiation.

FIG. 34 is the ³¹P {¹H} NMR spectrum of the crude etching mixture in C₆D₆ (3 eq. of benzoyl fluoride-λ_{etching}=427 nm-3 hours) from Example 13.

FIG. 35A is the UV-Vis spectrum and FIG. 35B is the PL (λ_{exc}=400 nm) temporal evolution for an etching experiment involving 1 eq. of oleylNH₃F of Examples 13 and 15. FIGS. 35C and 35D are STEM images of InP QDs of Example 13 before and after the etching process (1 eq. of oleylammonium fluoride-etching duration: 3 hours) (scale bar: 20 nm).

FIGS. 36A and 36B are photoluminescence spectra obtained before and after fluorine treatment for CdS (FIG. 36A) and ZnSe (FIG. 36B: 1 eq. of oleylammonium fluoride, λ_{fluorination}=400 nm (CdS) and 370 nm (ZnSe)).

FIG. 37 is the photoluminescence spectra obtained before (black line) and after (gray line) fluorine treatment for red-emitting InP/ZnS QDs (1 eq. of oleylammonium fluoride, λ_{fluorination}=400 nm) of Example 9.

### DETAILED DESCRIPTION OF ILLUSTRATIVE EMBODIMENTS

The present disclosure provides safe and inexpensive processes for etching quantum dots. Of particular importance, the processes do not employ hydrofluoric acid in either aqueous or gaseous forms. The processes can, in some embodiments, be performed in the absence of water, oxygen, or a combination thereof, thereby preserving properties of the quantum dots.

As is known in the art, the quantum dot contains a core and an optional shell/coating. In certain embodiments, the quantum dot contains a core. In other embodiments, the quantum dot contains a core and a shell. When the quantum dot contains a shell, the shell can be the same material as the core or can differ. In some embodiments, the core and shell materials of the quantum dot are the same. In other embodiments, the core and the shell materials of the quantum dot differ.

The present disclosure may be understood more readily by reference to the following description taken in connection with the accompanying Figures and Examples, all of which form a part of this disclosure. It is to be understood that this disclosure is not limited to the specific products, methods, conditions or parameters described or shown herein, and that the terminology used herein is for the purpose of describing particular embodiments by way of example only and is not intended to be limiting of any claimed disclosure. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values can be used to determine the intended range available to the term “about” for each value. Where present, all ranges are inclusive and combinable. That is, references to values stated in ranges include every value within that range.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present on a given atom, and, thus, the description includes structures wherein a non-hydrogen substituent is present and structures wherein a non-hydrogen substituent is not present.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such the combination is considered to be another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the disclosure. Embodiments described in terms of the phrase “comprising” (or its equivalents), also provide, as embodiments, those which are independently described in terms of “consisting of” and “consisting essentially of” For those embodiments provided in terms of “consisting essentially of,” the basic and novel characteristic(s) is the facile operability of the methods (and the systems used in such methods and the compositions derived therefrom) to prepare and use the inventive materials, and the materials themselves, where the methods and materials are capable of delivering the highlighted properties using only the elements provided in the claims. That is, while other materials may also be present in the inventive compositions, the presence of these extra materials is not necessary to provide the described benefits of those compositions or devices (i.e., the effects may be additive) and/or these additional materials do not compromise the performance of the product compositions or devices. Similarly, where additional steps may also be employed in the methods, their presence is not necessary to achieve the described effects or benefits and/or they do not compromise the stated effect or benefit.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.” This includes, without limitation, that a genus presenting multiple parameters, each parameter presenting multiple options, represents that collection of individual embodiments including any and every combination of these variables and options. By means of illustration only, a composition described in terms of two variables A and B, each variable presenting two options (a) and (b), includes, as independent embodiments, the subgenera A(a)-B(a), A(a)-B(b), A(b)-B(a), and A(b)-B(b). This principle can be applied to larger numbers of variables and options, such that any one or more of these variable or options can be independently claimed or excluded. Likewise, a definition such as C₁₋₃alkyl includes C₁alkyl, C₂alkyl, C₃alkyl, C₁₋₂alkyl, C₂₋₃alkyl, and C₁₋₃alkyl as separate embodiments.

Because each individual element of a list, and every combination of that list, is a separate embodiment, it should be apparent that any description of a genus or subgenus also included those embodiments where one or more of the elements are excluded, without the need for the disclosure of the exclusion. For example, a genus described as containing elements “A, B, C, D, E, or F” also includes the embodiments excluding one or more of these elements, for example “A, C, D, E, or F;” “A, B, D, E, or F;” “A, B, C, E, or F;” “A, B, C, D, or F;” “A, B, C, D, or E;” “A, D, E, or F;” “A, B, C, or F;” “A, E, or F;” “A, C, E, or F;” “A or F;” etc., without the need to explicitly delineate the exclusions.

### The Processes

The processes described herein include preparing etched quantum dots. In certain embodiments, the processes include etching Group III-V element quantum dots with an organic fluoride agent or an ammonium fluoride salt. In other embodiments, the processes include etching Group II-VI element quantum dots with an organic fluoride agent or ammonium fluoride salt.

The term “etching” as used herein refers to the fluorination of quantum dots. Depending on the quantum dot, etching can also refer to one or more of dissolving the surface of the quantum dot, shrinking the size of the quantum dot, or passivating the surface of the quantum dot. In some embodiments, “etching” III-V quantum dots includes dissolving the surface of the quantum dot, shrinking the size of the quantum dot, and fluorinating the quantum dot. In other embodiments, “etching” II-VI quantum dots includes passivating the surface of the quantum dot and fluorinating the quantum dot.

In some embodiments, the etching is performed with at least a stoichiometric amount, i.e., one equivalent, of the organic fluoride agent or the ammonium fluoride salt. In other embodiments, the etching is performed with more than one stoichiometric amount, i.e., an excess, of the organic fluoride. In other embodiments, the etching is performed with an about 2, about 3, about 3, about 4, about 5, about 10, about 15, about 20, about 25, about 30, about 35, about 40, about 45, or about 50 molar excess of the organic fluoride. In other embodiments, the etching is performed with about 2, about 3, about 3, about 4, about 5, about 10, about 15, about 20, about 25, about 30, about 35, about 40, about 45, or about 50 equivalents of the organic fluoride. In further aspects, the etching is performed using a sub-stoichiometric amount, i.e., less than about one equivalent, of the organic fluoride agent or an ammonium salt.

The etching can be performed at room temperature or a temperature above room temperature, i.e., elevated temperature. In some embodiments, the etching is performed at the reflux temperature of the solvent used in the etching process. For example, the etching can be performed at a temperature of at least about 25, about 30, about 35, about 40, about 45, about 50, about 60, about 70, about 80, about 90, about 100, about 110, about 120, about 130, about 140, about 150, about 160, about 170, about 180, about 190, or about 200° C.

Alternatively or in addition to elevated temperatures, etching can be performed using light. In some aspects, the light is a wavelength that is absorbed by the quantum dots. In one example, the light is blue light (e.g., 450 nm).

Etching can also be performed under standard laboratory conditions of under inert conditions, i.e., anaerobic conditions. For example, etching can be performed in the absence of water, oxygen, or a combination thereof.

The etching can further be performed in the presence of one or more surfactants. By doing so, the quantum yield can increase and/or the quantum dots are made more colloidally stable. In some embodiments, the surfactant is added to the quantum dot. In other embodiments, the quantum dot already contains a surfactant. In some embodiments, the surfactant is an oleyl amine such as n-alkylamines and n-alcohols. Examples include oleylamine, hexadecanol, and hexadecane diol. In some embodiments, the surfactant leads to the production of HF. Etching can be performed with stoichiometric amounts of surfactant or excess amounts. The surfactant can present be in free form, bound to the surface of the quantum dots, or a combination thereof. When the surfactant is bound to the quantum dot, the organic fluoride reacts with surfactant, resulting in the addition of hydrofluoric acid (HF) to the bound surfactant molecule.

After etching, the etched quantum dots can be shelled. One of skill in the art would readily understand the processes entailed with shelling etched quantum dots. In some embodiments, the shelling is performed in the presence of one or more materials to prepare the shell. The additional material can be determined by one skilled in the art.

The shell can have a narrower or wider bandgap than the core. In some embodiments, the shell, is a wider band-gap material than the core. In further embodiments, the shell is a narrower band-gap material than the core.

In other embodiments, the material is X′—Y′, wherein X′ is a Group 12 metal and Y′ is a Group 6 element, such as ZnO, ZnS, ZnSe, CdS, CdSe, CdTe, HgS, HgSe, HgTe, or a combination thereof, or such as ZnS, ZnSe, or ZnS/ZnSe. In further embodiments, the material is ZnO. In still other embodiments, the material is ZnS. In yet further embodiments, the material is ZnSe. In other embodiments, the material is CdS. In further embodiments, the material is CdSe. In still other embodiments, the material is CdTe. In further embodiments, the material is HgS. In yet other embodiments, the material is HgSe. In still further embodiments, the material is HgTe. The material also can be another Group III-V element as detailed below.

### Organic Fluoride Agent

The organic fluoride agent can selected by one skilled in the art. The term “organic fluoride agent” as used herein refers a fluoride agent that contains one or more C—F or S—F or N—F bonds. See, e.g., Rozatian, “Reactivities of electrophilic N-Fluorinating reagents,” ChemComm., 2021, 57, 683, which is incorporated by reference. In certain aspects, the organic fluoride agent is immiscible with water. The inventor hypothesize that the organic fluoride agent removes oxide from the surface of the quantum dot, thereby leading to improvements in quantum yields. Treatment with the organic fluoride agent also results in a blue-shift in the band-edge absorption, corresponding to an overall decrease in nanocrystal size, and narrowing of the line-width.

In certain embodiments, the organic fluoride agent is an electrophilic fluoride agent. For example, the electrophilic fluoride agent can be N-fluorobenzenesulfonimide, an N-fluoropyridinium compound, 1-chloromethyl-4-fluoro-1,4-diazoniabicyclo[2.2.2]octane bis(tetrafluoroborate) (Selectfluor), or a 1-chloromethyl-4-fluoro-1,4-diazoniabicyclo[2.2.2]octane bis(tetrafluoroborate derivative.

In some embodiments, the N-fluoropyridinium compound is of formula I:

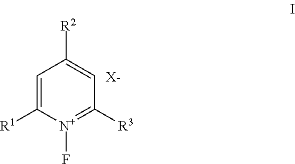

In this structure of formula I, R¹, R², and R³ are, independently, halo or C₁₋₆alkyl. In some embodiments, R¹ is halo, such as F, Cl, or Br, or such as C₁. In other embodiments, R¹ is C₁₋₆alkyl, such as methyl, ethyl, propyl, butyl, pentyl, or hexyl, or such as methyl. In further embodiments, R² is halo, such as F, Cl, or Br, such as Cl. In yet other embodiments, R² is C₁₋₆alkyl, such as methyl, ethyl, propyl, butyl, pentyl, or hexyl, or such as methyl. In still further embodiments, R³ is halo, such as F, Cl, or Br, such as Cl. In other embodiments, R³ is C₁₋₆alkyl, such as methyl, ethyl, propyl, butyl, pentyl, or hexyl, or such as methyl. Also in formula I, X⁻ is ⁻BF₄, ⁻OTf, ⁻PF₆, or ⁻NO₃. In some embodiments, X⁻ is ⁻BF₄. In other embodiments, X⁻ is ⁻OTf. In further embodiments, X⁻ is ⁻PF₆. In still other embodiments, X⁻ is ⁻NO₃.

Alternatively, the organic fluoride agent is a nucleophilic fluoride agent. In some embodiments, the nucleophilic fluoride agent is a sulfonyl fluoride compound, acyl fluoride, tetrahydro-1,3-dimethyl-2(1H)-pyrimidinone hydrofluoride (DMPU-HF), or triethylamine trihydrofluoride (TREAT-HF). In other embodiments, the nucleophilic fluoride agent is TREAT-HF. In further embodiments, the nucleophilic fluoride agent is DMPU-HF. In yet other embodiments, the nucleophilic fluoride agent is a sulfonyl fluoride compound. For example, the sulfonyl fluoride compound is of formula IIA or IIB:

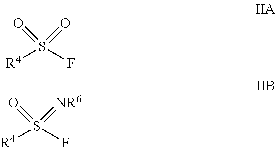

In the structure of formula IIA, R⁴ is H, optionally substituted C₁₋₆alkyl, optionally substituted C₂₋₆alkenyl optionally substituted heteroaryl, or optionally substituted aryl. In some embodiments, R⁴ is H. In other embodiments, R⁴ is optionally substituted C₁₋₆alkyl, such as methyl, ethyl, propyl, butyl, pentyl, or hexyl, or such as methyl, benzyl, or bromomethyl. In further embodiments, R⁴ is optionally substituted C₂₋₆alkenyl, such as ethenyl, propenyl, butenyl, pentenyl, or hexenyl, or such as ethenyl or benzyl. In yet other embodiments, R⁴ is optionally substituted aryl such as phenyl, naphthyl, or indolyl. In still further embodiments, R⁴ is optionally substituted phenyl such as 4-tolyl. In other embodiments, R⁴ is optionally substituted heteroaryl such as pyridinyl. In other examples, the sulfonyl fluoride is pyridine-2-sulfonyl fluoride (PyFluor), ethenesulfonyl fluoride, benzylsulfonyl fluoride, 4-methylbromosulfonyl fluoride, 4-tolyl-sulfonyl fluoride. In some aspects, the sulfonyl fluoride is PyFluor. In other aspects, the sulfonyl fluoride is ethenesulfonyl fluoride. In further aspects, the sulfonyl fluoride is benzylsulfonyl fluoride. In yet other aspects, the sulfonyl fluoride is 4-methylbromosulfonyl fluoride. In still further aspects, the sulfonyl fluoride is 4-tolyl-sulfonyl fluoride. In other aspects, the sulfonyl fluoride is one as described in “SuFEx: Sulfonyl Fluorides that Participate in the Next Click Reaction,” Millapore Sigma, 2022, https://www.sigmaaldrich.com/US/en/technical-documents/technical-article/chemistry-and-synthesis/ch-functionalization/sulfonyl-fluorides, which is incorporate herein by reference.

In the structure of formula IIB, R⁶ is H or C₁₋₆alkyl. In some embodiments, R⁶ is H. In other embodiments, R⁶ is C₁₋₆alkyl, such as methyl, ethyl, propyl, butyl, pentyl, or hexyl, or such as methyl.

In other embodiments, the nucleophilic fluoride agent is an acyl fluoride. For example, the acylfluoride is of formula III:

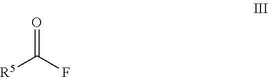

In the structure for Formula III, R⁵ is C₁₋₆alkyl, aryl, or heteroaryl. In some embodiments, R⁵ is optionally substituted C₁₋₆alkyl, such as methyl, ethyl, propyl, butyl, pentyl, or hexyl, or such as methyl, benzyl, or bromomethyl. In other embodiments, R⁵ is optionally substituted C₂₋₆alkenyl, such as ethenyl, propenyl, butenyl, pentenyl, or hexenyl, or such as ethenyl or benzyl. In further embodiments, R⁵ is optionally substituted aryl such as phenyl, naphthyl, or indolyl. In yet other embodiments, R⁵ is optionally substituted phenyl such as 4-tolyl. In still further embodiments, R⁵ is optionally substituted heteroaryl such as pyridinyl. In certain examples, the acylfluoride is benzoyl fluoride.

The term “alkyl” as used herein refers to a linear, branched, or cyclic saturated hydrocarbon group typically although not necessarily containing 1 to about 30 carbon atoms, in some cases, from 1 to about 12 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like, or in other cases from about 12 to about 24 or 30 carbon atoms (e.g., oleic and other fatty or saturated acids). Generally, alkyl groups herein can also contain 1 to about 12 carbon atoms or 1 to 6 carbon atoms. The term “cycloalkyl” intends a cyclic alkyl group, typically having 4 to 8, preferably 5 to 7, carbon atoms. The term “substituted alkyl” refers to alkyl groups substituted with one or more substituent groups, and the terms “heteroatom-containing alkyl” and “heteroalkyl” refer to alkyl groups in which at least one carbon atom is replaced with a heteroatom. If not otherwise indicated, “alkyl” include linear, branched, cyclic, unsubstituted, substituted, and/or heteroatom-containing alkyl groups.

The term “alkenyl” as used herein refers to a linear, branched, or cyclic hydrocarbon group of 2 to about 30 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. In some embodiments, alkenyl groups contain 2 to about 12 carbon atoms, preferably 2 to about 6 carbon atoms. “Alkenyl” also includes vinyl groups, wherein the double bond is at a terminal location of the molecule. The term “substituted alkenyl” refers to alkenyl groups substituted with one or more substituent groups. If not otherwise indicated, the term “alkenyl” includes linear, branched, cyclic, unsubstituted, and/or substituted alkenyl groups, respectively.

The term “aryl” as used herein, and unless otherwise specified, refers to an aromatic substituent or structure containing a single aromatic ring or multiple aromatic rings that are fused together, directly linked, or indirectly linked (such that the different aromatic rings are bound to a common group such as a methylene or ethylene moiety). In some embodiments, the aryl ring is unfused. In other embodiments, the aryl is a fused aryl. In further embodiments, the aryl is a bridged aryl. Unless otherwise modified, the term “aryl” refers to carbocyclic structures. Preferred aryl groups contain 5 to 24 carbon atoms, and particularly preferred aryl groups contain 5 to 14 carbon atoms. Exemplary aryl groups contain one aromatic ring or two fused or linked aromatic rings, e.g., phenyl, naphthyl, biphenyl, diphenylether, diphenylamine, benzophenone, and the like.

The terms “halo,” “halide,” and “halogen” are used in the conventional sense to refer to a chloro, bromo, fluoro, or iodo substituent.

The term “heteroaryl” refers to “aryl” that contains one or more oxygen, sulfur, or nitrogen heteroatom. In some embodiments, the heteroaryl contains at least one nitrogen heteroatom, i.e., a N-containing heteroaryl. “Heterocycles” can be monocyclic, bicyclic, or polycyclic as described above with respect to the term “aryl.” Non-limiting examples of heteroaryl groups include azepinyl, acridinyl, carbazolyl, cinnolinyl, furanyl, furazanyl, furanonyl, isothiazolyl, imidazolyl, indazolyl, indolyl, isoindolyl, indolinyl, isoindolinyl, isoquinolyl, indolizinyl, isoxazolyl, naphthyridinyl, oxadiazolyl, oxazolyl, oxiranyl, phenazinyl, phenothiazinyl, phenoxazinyl, phthalazinyl, pteridinyl, purinyl, pyranyl, pyrrolyl, pyrrolidinyl, pyrazolyl, pyridinyl, pyrazinyl, pyrimidinyl, pyridazinyl, quinazolinyl, quinoxalinyl, quinolinyl, isoquinolinyl, tetrahydroquinolinyl, thiazolyl, thiadiazolyl, thiapyranyl, triazolyl, tetrazolyl, triazinyl, and thiophenyl. Non-limiting examples of heteroatom-containing alicyclic groups are pyrrolidino, morpholino, piperazino, and piperidino.

The term “sulfonyl” refers to the SO₂ group.

By “substituted” as in “substituted alkyl,” “substituted aryl,” and the like, as alluded to in some of the aforementioned definitions, is meant that in the alkyl, aryl, heteroaryl, or other moiety, at least one hydrogen atom bound to a carbon (or other) atom is replaced with one or more non-hydrogen substituents. Examples of such substituents include, without limitation, halo (e.g., F, Cl, Br, I), OH, alkoxy, acyl (including alkylcarbonyl, arylcarbonyl, acyloxy (alkylcarbonyloxy and arylcarbonyloxy), alkoxycarbonyl, aryloxycarbonyl, carboxy, carboxylate), carbamoyl, di-N-(alkyl), NH₂, mono-(alkyl)-substituted amino, di-(alkyl)-substituted amino, mono-(aryl)substituted amino, di-(aryl)-substituted amino, alkyl, alkenyl, and alkynyl, aryl.

The fluoride agent can be selected from fluoride agents in the art. For example, the fluoride agent can be, wherein X (if undefined) is a counterion such as BF₄⁻, OTf, or PF₆⁻ and R is C₁₋₆alkyl, aryl, or heteroaryl.

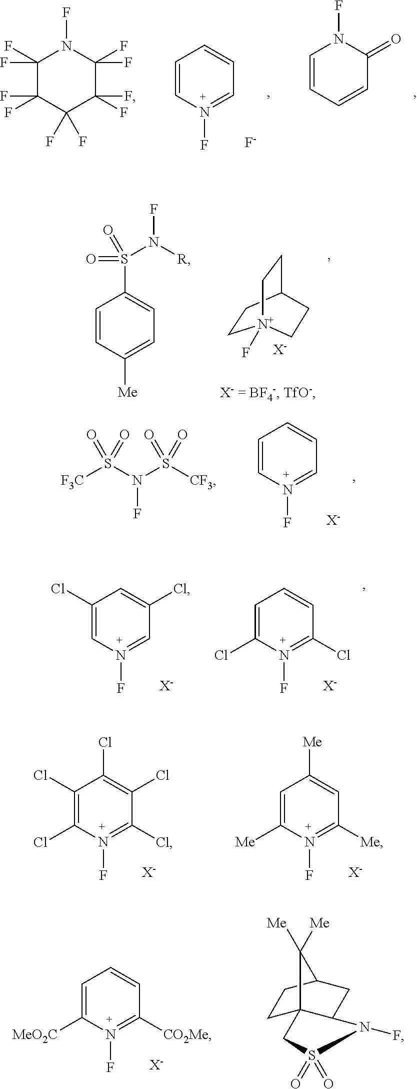

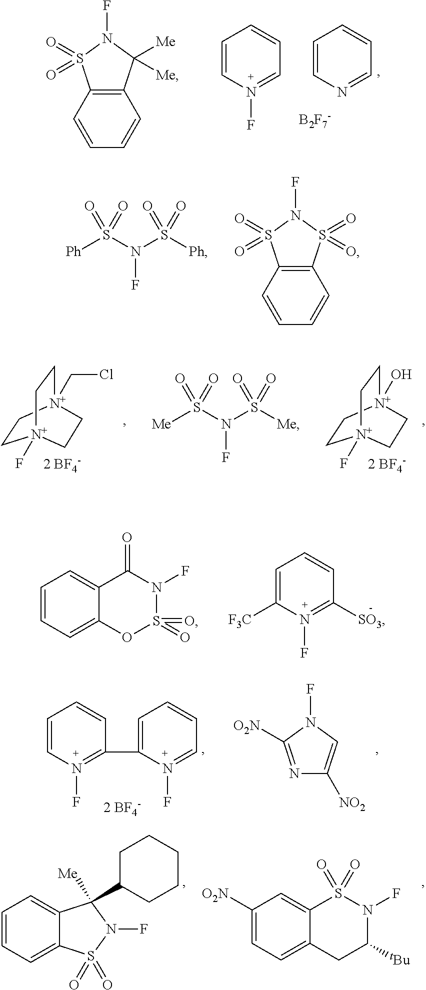

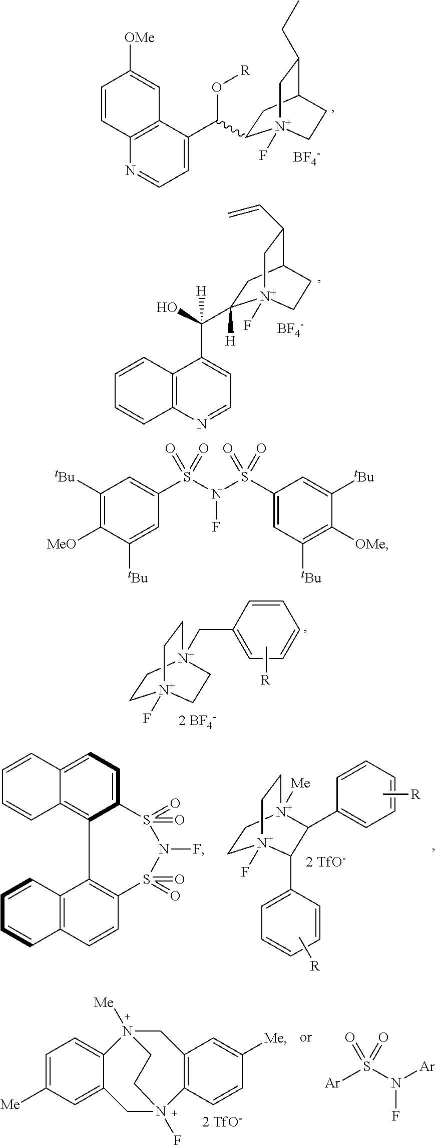

### The Ammonium Fluoride Salt

The etching described herein can also be performed using an ammonium fluoride salt. In some aspects, the ammonium fluoride salt is ammonium fluoride (NH₄F). In other aspects, the ammonium fluoride is ammonium bifluoride ([NH₄F][HF]).

In some embodiments, the ammonium fluoride salt is an organic ammonium fluoride salt. In certain aspects, the organic ammonium fluoride salt is [NHR¹⁰R¹¹R¹²]F, wherein R¹⁰, R¹¹, and R¹² are, independently, H, optionally substituted C₁₋₂₀alkyl, optionally substituted C₁₋₂₀alkenyl, optionally substituted C₁₋₂₀alkynyl, optionally substituted C₃₋₁₀cycloalkyl, or optionally substituted aryl; or R¹⁰ is absent and R¹¹ and R¹² are combined to form a 5 to 8-membered heterocyclyl or heteroaryl. In certain embodiments, R¹⁰ is H. In other embodiments, R¹¹ is H. In further embodiments, R¹² is H. In some embodiments, R¹⁰ is optionally substituted C₁₋₂₀alkyl. In other embodiments, R¹¹ is optionally substituted C₁₋₂₀alkyl. In further embodiments, R¹² is optionally substituted C₁₋₂₀alkyl. In yet other embodiments, R¹⁰ is optionally substituted C₁₋₂₀alkenyl. In still further embodiments, R¹¹ is optionally substituted C₁₋₂₀alkenyl. In other embodiments, R¹² is optionally substituted C₁₋₂₀alkenyl. In further embodiments, R¹⁰ is optionally substituted C₁₋₂₀alkynyl. In still other embodiments, R¹¹ is optionally substituted C₁₋₂₀alkynyl. In yet further embodiments, R¹² is optionally substituted C₁₋₂₀alkynyl. In other embodiments, R¹⁰ is optionally substituted C₃₋₁₀cycloalkyl. In further embodiments, R¹¹ is optionally substituted C₃₋₁₀cycloalkyl. In still other embodiments, R¹² is optionally substituted C₃₋₁₀cycloalkyl. In yet further embodiments, R¹⁰ is optionally substituted aryl. In other embodiments, R¹¹ is optionally substituted aryl. In further embodiments, R¹² is optionally substituted aryl. In yet other embodiments, the organic ammonium fluoride agent is triethylammonium fluoride, oleylammonium fluoride, pyridinium fluoride, oleylammonium bifluoride, combinations thereof.

In other aspects, the ammonium fluoride salt is [R¹³F]⁺X⁻, wherein R¹³ is an optionally substituted N-containing heterocyclyl or optionally substituted N-containing heteroaryl, wherein F is bound to the nitrogen atom of R¹³ and X⁻ is a counterion such as BF₄⁻, OTf, or PF₆⁻. In some embodiments, R¹³ is an optionally substituted N-containing heterocyclyl. In other embodiments, R¹³ is optionally substituted N-containing heteroaryl such as pyridyl, imidazolyl, and the like.

In other aspects, the ammonium fluoride salt is [R¹³H]⁺F⁻, wherein R¹³ is an optionally substituted N-containing heterocyclyl or optionally substituted N-containing heteroaryl, wherein H of [R¹³H]⁺ is bound to the nitrogen atom of R¹³ and F⁻ is a counterion. In some embodiments, R¹³ is an optionally substituted N-containing heterocyclyl. In other embodiments, R¹³ is optionally substituted N-containing heteroaryl such as pyridyl, imidazolyl, and the like.

In further aspects, the ammonium fluoride salt is [NHR¹⁰R¹¹R¹²][HF₂], wherein R¹⁰, R¹¹, and R¹² are, independently, optionally substituted C₁₋₂₀alkyl, optionally substituted C₁₋₂₀alkenyl, optionally substituted C₁₋₂₀alkynyl, optionally substituted C₃₋₁₀cycloalkyl, or optionally substituted aryl. In certain embodiments, R¹⁰ is H. In other embodiments, R¹¹ is H. In further embodiments, R¹² is H. In some embodiments, R¹⁰ is optionally substituted C₁₋₂₀alkyl. In other embodiments, R¹¹ is optionally substituted C₁₋₂₀alkyl. In further embodiments, R¹² is optionally substituted C₁₋₂₀alkyl. In yet other embodiments, R¹⁰ is optionally substituted C₁₋₂₀alkenyl. In still further embodiments, R¹¹ is optionally substituted C₁₋₂₀alkenyl. In other embodiments, R¹² is optionally substituted C₁₋₂₀alkenyl. In further embodiments, R¹⁰ is optionally substituted C₁₋₂₀alkynyl. In still other embodiments, R¹¹ is optionally substituted C₁₋₂₀alkynyl. In yet further embodiments, R¹² is optionally substituted C₁₋₂₀alkynyl. In other embodiments, R¹⁰ is optionally substituted C₃₋₁₀cycloalkyl. In further embodiments, R¹¹ is optionally substituted C₃₋₁₀cycloalkyl. In still other embodiments, R¹² is optionally substituted C₃₋₁₀cycloalkyl. In yet further embodiments, R¹⁰ is optionally substituted aryl. In other embodiments, R¹¹ is optionally substituted aryl. In further embodiments, R¹² is optionally substituted aryl.

The “alkyl,” “alkenyl,” “aryl,” and “heteroaryl” groups are as defined for the compound of Formula III. The term “alkynyl” as used herein refers to a linear, branched, or cyclic hydrocarbon group of 2 to about 30 carbon atoms containing at least one triple bond, such as ethynyl, n-propynyl, isopropynyl, n-butynyl, isobutynyl, octynyl, decynyl, tetradecynyl, hexadecynyl, eicosynyl, tetracosynyl, and the like. In some embodiments, alkynyl groups contain 2 to about 12 carbon atoms, or 2 to about 6 carbon atoms. The term “substituted alkynyl” refers to alkenyl groups substituted with one or more substituent groups. If not otherwise indicated, the term “alkynyl” includes linear, branched, cyclic, unsubstituted, and/or substituted alkenyl groups, respectively.

“Heterocyclyl” refers to a stable 3- to 18-membered non-aromatic ring that comprises two to twelve carbon atoms and from one to six heteroatoms that are from nitrogen, oxygen or sulfur. In certain aspects, the heterocyclyl contains at least one N-atom, i.e., a N-containing heterocyclyl. In some embodiments, the heterocyclyl contains 3 ring atoms, 4 ring atoms, etc., up to and including 18 ring atoms. The heterocyclyl is a monocyclic, bicyclic, tricyclic or tetracyclic ring system, which can include fused or bridged ring systems. The heteroatoms in the heterocyclyl can be optionally oxidized. One or more nitrogen atoms, if present, are optionally quaternized. The heterocyclyl is partially or fully saturated. The heterocyclyl can be attached to the rest of the molecule through any atom of the ring(s). In some embodiments, Examples of heterocyclyl include, but are not limited to, azepanyl, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, azetidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. “Heterocyclyl” also includes bicyclic ring systems wherein one non-aromatic ring, usually with 3 to 7 ring atoms, contains at least 2 carbon atoms in addition to 1-3 heteroatoms independently selected from oxygen, sulfur, and nitrogen, as well as combinations comprising at least one of the foregoing heteroatoms; and the other ring, usually with 3 to 7 ring atoms, optionally contains 1-3 heteroatoms independently selected from oxygen, sulfur, and nitrogen and is not aromatic.

The term “cycloalkyl” refers to non-aromatic hydrocarbon groups having 3 to 10 carbon atoms (“C₃-10”), such as 3 to 6 carbon atoms (“C₃₋₆”). Examples of cycloalkyl groups include, for example, cyclopropyl, cyclobutyl, cyclopentyl, cyclohexyl, and the like. In some embodiments, the cycloalkyl is monocyclic, bicyclic, or bridged. In some embodiments, the cycloalkyl is monocyclic. In other embodiments, the cycloalkyl is bicyclic. In further embodiments, the cycloalkyl is bridged.

The term “substituted” used herein refers to the referenced chemical group that has one or more substituents. Suitable substituents include, without limitation, halo (F, Cl, Br, or I), SH, OH, C₁₋₆alkyl, OC₁₋₆alkyl, CN, NH₂, NH(C₁₋₆alkyl), NH(C₁₋₆alkyl)₂, C₃₋₈cycloalkyl, heterocyclyl, aryl, or heteroaryl.

### Group III-V Quantum Dots

The quantum dots described herein comprise Group III-V elements. In some embodiments, the quantum dot includes one or two Group III elements. In other embodiments, the quantum dot includes one Group III element. In further embodiments, the quantum dot includes two Group III elements. In yet other embodiments, the quantum dot includes three or more Group III elements. For such quantum dots, the Group III-V elements form the core of the quantum dot.

The Group III element can be selected by and will be known to those skilled in the art. In some embodiments, the Group III element is aluminum (Al), gallium (Ga), or indium (In), or combination thereof. In other embodiments, the Group III element is Al. In further embodiments, the Group III element is Ga. In yet other embodiments, the Group III element is In.

The quantum dots described herein also include a Group V element. In some embodiments, the quantum dot includes one or two Group V elements. In other embodiments, the quantum dot includes one Group V element. In further embodiments, the quantum dot includes two Group V elements. In yet other embodiments, the quantum dot includes three or more Group V elements.

The Group V element can be selected by and will be known to those skilled in the art. In some embodiments, the Group V element is nitrogen (N), phosphorus (P), arsenic (As), antimony (Sb), or bismuth (Bi), or combinations thereof. In other embodiments, the Group V element is N. In further embodiments, the Group V element is P. In still other embodiments, the Group V element is As. In yet further embodiments, the Group V element is Bi.

In certain embodiments, the quantum dot includes one Group III element and one Group V element. In other embodiments, the quantum dot contains two Group III elements and one Group III element. Examples of quantum dots include, without limitation, GaP, InP, GaAs, InAs, InGaP, or AlP, or combinations thereof.

In some aspects, the etched quantum dot comprises a core that is A′-B′, wherein A′ is a Group III element and Group V element as described above. In certain embodiments, A′ is Al. In further embodiments, A′ is Ga. In other embodiments, A′ is In. In yet other embodiments, B′ is N. In further embodiments, B′ is P. In other embodiments, B′ is As. In still further embodiments, B′ is Sb. In yet other embodiments, B′ is Bi. In further embodiments, A′-B′ is GaP, InP, GaAs, InAs, or AlP.

The etched III-V quantum dot can further comprise one or more shells. In some embodiments, the etched III-V quantum dot contains one shell. In further embodiments, the etched III-V quantum dot contains two shells. In other embodiments, the etched quantum dot contains three shells. In still further embodiments, the etched quantum dot contains four or more shells. The shells can be the same as one another, i.e., contain the same elements or the shells can differ from one another, i.e., contains different elements.

In certain aspects, the etched III-V quantum dot comprises a first shell that is A″-B″ or A″-C″-B″, wherein A″ and C″ are Group III elements and B″ is a Group V element as described above. In some aspects, A″ and C″ are the same element. In other aspects, A″ and C″ are different elements. In certain embodiments, A″ and C are, independently, Al. In further embodiments, A″ and C are, independently, Ga. In other embodiments, A″ and C are, independently, In. In yet other embodiments, B″ is N. In further embodiments, B″ is P. In other embodiments, B″ is As. In still further embodiments, B″ is Sb. In yet other embodiments, B″ is Bi. In further embodiments, A″-B″ is GaP, InP, InS, GaAs, InAs, or AlP. In other embodiments, A″-C″-B″ is InGaP.

In other aspects, the etched quantum dot comprises a first shell that is X′—Y′, wherein X′ is a Group 12 metal and Y′ is a Group 6 element. In certain embodiments, X′ is Group 12 metal such as Zn, Cd, or Hg. In other embodiments, X′ is Zn. In further embodiments, X′ is Cd. In yet other embodiments, X′ is Hg. In still further embodiments, Y′ is a Group 6 element such as O, S, Se, or Te. In other embodiments, Y′ is O. In further embodiments, Y′ is S. In still other embodiments, Y′ is Se. In yet further embodiments, Y′ is Te. In other embodiments, X′—Y′ is ZnO, ZnS, ZnSe, CdS, CdSe, CdTe, HgS, HgSe, or HgTe. In further embodiments, X′—Y is ZnS or ZnSe.

The etched quantum dot can contain additional shells, i.e., second shell, third shell, or more, as described herein. In further aspects, additional shell is X″—Y″, wherein X″ is a Group 12 metal and Y″ is a Group 6 element provided that. In certain embodiments, X″ is Group 12 metal such as Zn, Cd, or Hg. In other embodiments, X″ is Zn. In further embodiments, X″ is Cd. In yet other embodiments, X″ is Hg. In still further embodiments, Y″ is a Group 6 element such as O, S, Se, or Te. In other embodiments, Y″ is O. In further embodiments, Y″ is S. In still other embodiments, Y″ is Se. In yet further embodiments, Y″ is Te. In some aspects, X′—Y′ and X″—Y″ are not the same. In other aspects, X″—Y″ is a heterostructure.

The additional shell(s), i.e., second shell, third shell, or more, can be P′Q′R′ or P′₁₋ₓQ′ₓR′. In these structure, P′ is a Group 12 metal, Q′ is a Group 12 metal, E′ is a Group 6 element and x is 0.01 to 0.99. In certain embodiments, P′ and Q′ are, independently, a Group 12 metal such as Zn, Cd, or Hg. In other embodiments, P′ and Q′ are, independently, Zn. In further embodiments, P′ and Q′ are, independently, Cd. In yet other embodiments, P′ and Q′ are, independently, Hg. In still further embodiments, E′ is a Group 6 element such as O, S, Se, or Te. In other embodiments, E′ is O. In further embodiments, E′ is S. In still other embodiments, E′ is Se. In yet further embodiments, E′ is Te.

In certain embodiments, the III-V quantum dots comprise a core that is InAs and a shell that is CdS. In other embodiments, the III-V quantum dots comprise a core that is InAs and a shell that is CdSe. In other embodiments, the III-V quantum dots comprise a core that is InAs and a shell that is CdTe. In other embodiments, the III-V quantum dots comprise a core that is InAs and a shell that is ZnS. In other embodiments, the III-V quantum dots comprise a core that is InAs and a shell that is ZnSe. In other embodiments, the III-V quantum dots comprise a core that is InAs and a shell that is ZnTe. In other embodiments, the III-V quantum dots comprise a core that is InAs and a shell that is CdS. In other embodiments, the III-V quantum dots comprise a core that is InP and a shell that is CdSe. In other embodiments, the III-V quantum dots comprise a core that is InP and a shell that is CdTe. In other embodiments, the III-V quantum dots comprise a core that is InP and a shell that is ZnS. In other embodiments, the III-V quantum dots comprise a core that is InP and a shell that is ZnSe. In other embodiments, the III-V quantum dots comprise a core that is InP and a shell that is ZnTe. In other embodiments, the III-V quantum dots comprise a core that is GaP and a shell that is ZnS. In other embodiments, the III-V quantum dots comprise a core that is GaP and a shell that is ZnSe. In other embodiments, the III-V quantum dots comprise a core that is GaP and a shell that is ZnTe.

The disclosure further provides processes for generating light from quantum dots comprising Group III-V elements. The processes include applying energy to the etched quantum dots to provide excited quantum dots. Energy can be applied using e.g., heat or light. In some embodiments, the generated light has a narrower emission spectral linewidth than light generated from comparable quantum dots etched with hydrofluoric acid or compared with quantum dots prior to etching. The etched quantum dots can also or in addition can be shelled using techniques known in the art as described above.

### Group II-VI Quantum Dots

The quantum dots described herein comprise Group II-VI elements. In some embodiments, the quantum dot includes one or two Group II elements. In other embodiments, the quantum dot includes one Group II element. In further embodiments, the quantum dot includes two Group II elements. In yet other embodiments, the quantum dot includes three or more Group II elements.

The Group II element can be selected by those skilled in the art. In some embodiments, the Group II element is zinc (Zn), cadmium (Cd), or mercury (Hg). In some embodiments, the Group II element is Zn. In other embodiments, the Group II element is Cd. In further embodiments, the Group II element is Hg.

The quantum dots described herein also include a Group VI element. In some embodiments, the quantum dot includes one or two Group VI elements. In other embodiments, the quantum dot includes one Group VI element. In further embodiments, the quantum dot includes two Group VI elements. In yet other embodiments, the quantum dot includes three or more Group VI elements.

The Group VI element can be selected by and be known to those skilled in the art. In some embodiments, the Group VI element is oxygen (O), sulfur (S), selenium (Se), or tellurium (Te). In other embodiments, the Group VI element is O. In further embodiments, the Group VI element is S. In still other embodiments, the Group VI element is Se. In yet further embodiments, the Group VI element is Te.

In certain embodiments, the quantum dot includes one Group II element and one Group VI element. In other embodiments, the quantum dot contains two Group II elements and one Group VI element. Examples of Group II-VI quantum dots include, without limitation, HgTe, HgSe, HgS, CdTe, CdSe, CdS, ZnTe, ZnSe, or ZnS, or combinations thereof.

In some aspects, the etched quantum dot comprises a core that is X—Y, wherein X is a Group II and Y is a Group VI element as recited herein. In some embodiments, X is zinc (Zn), cadmium (Cd), or mercury (Hg). In other embodiments, X is Zn. In further embodiments, X is Cd. In yet other embodiments, X is Hg. In still further embodiments, Y is oxygen (O), sulfur (S), selenium (Se), or tellurium (Te). In other embodiments, Y is O. In further embodiments, Y is S. In still other embodiments, Y is Se. In yet further embodiments, Y is Te. In other embodiments, X—Y is CdSe, CdS, or ZnS.

The etched II-VI quantum dot can further comprise one or more shells. In some embodiments, the etched II-VI quantum dot contains one shell. In further embodiments, the etched II-VI quantum dot contains two shells. In other embodiments, the etched II-VI quantum dot contains three shells. In still further embodiments, the etched II-VI quantum dot contains four or more shells. The shells can be the same as one another, i.e., contain the same elements or the shells can differ from one another, i.e., contains different elements.

In certain aspects, the etched II-VI quantum dot comprises a first shell that is A′-B′ or A′-C′-B′, wherein A′ and C′ are Group III elements and B′ is a Group V element as described above. In some aspects, A′ and C′ are the same element. In other aspects, A′ and C′ are different elements. In certain embodiments, A″ and C are, independently, a Group 3 element and B′ is a Group 5 element. In other embodiments, A′ and C′ are, independently, Al. In still further embodiments, A′ and C′ are, independently, Ga. In other embodiments, A′ and C′ are, independently, In. In yet other embodiments, B′ is N. In further embodiments, B′ is P. In other embodiments, B′ is As. In still further embodiments, B′ is Sb. In yet other embodiments, B′ is Bi. In further embodiments, A′-B′ is GaP, InP, InS, GaAs, InAs, or AlP. In other embodiments, A′-C′-B′ is InGaP.

In other aspects, the etched II-VI quantum dot comprises a first shell that is M-Q or M-P-Q, wherein X′ is a Group 12 metal and Y′ is a Group 6 element as described above. In some aspects, M and P are the same element. In other aspects, M and P are different elements. In certain embodiments, M and P are, independently, Zn, Cd, or Hg. In other embodiments, M and P are, independently, Zn. In further embodiments, M and P are, independently, Cd. In yet other embodiments, M and P are, independently, Hg. In still further embodiments, Q′ is O, S, Se, or Te. In other embodiments, Q is O. In further embodiments, Q is S. In still other embodiments, Y′ is Se. In yet further embodiments, Q is Te. In other embodiments, M-Q is ZnO, ZnS, ZnSe, CdS, CdSe, CdTe, HgS, HgSe, or HgTe. In further embodiments, M-Q is ZnS or ZnSe.

The etched II-VI quantum dot can contain additional shells, i.e., second shell, third shell, or more, as described herein. In further aspects, additional shell is F′-G′, wherein F″ is a Group 3 element and G′ is a Group 5 element. In certain embodiments, F′ is Al, Ga, or In. In further embodiments, F′ is Al. In yet other embodiments, F′ is Ga. In further embodiments, F′ is In. In still further embodiments, G′ is a N, P, As, or Sb. In other embodiments, G′ is N. In further embodiments, G′ is P. In still other embodiments, G′ is As. In yet further embodiments, G′ is Sb. In some aspects, F′-G′ and M-Q are not the same. In other aspects, F′-G′ is a heterostructure. In other embodiments, the quantum dot contains two shells that are InP and GaP (InP/GaP) or InAs and GaAs (InAs/GaAs).

The additional shell(s), i.e., second shell, third shell, or more, can be C′D′E′ or C′₁₋ₓD′ₓE′. In these structures, C′ and D′; are, independently, a Group 3 element, E′ is a Group 5 element, and x is 0.01 to 0.99. In certain embodiments, C′ and D′ are, independently, Al, Ga, or In. In further embodiments, C′ and D′ are, independently, Al. In yet other embodiments, C′ and D′ are, independently, Ga. In further embodiments, C′ and D are, independently, In. In still further embodiments, E′ is N, P, As, or Sb. In other embodiments, E′ is N. In further embodiments, E′ is P. In still other embodiments, E′ is As. In yet further embodiments, E′ is Sb. In yet further embodiments, C′D′E′ is InGaP. In other embodiments, C′₁₋ₓD′ₓE′ is In₁₋ₓGaₓP or In In₁₋ₓGaₓAs. In some embodiments, C′₁₋ₓD′ₓE′ is an alloy In other embodiments, C′₁₋ₓD′ₓE′ is a solid solution.

In certain embodiments, the II-VI quantum dot comprises a core that is CdSe and a shell that is ZnS.

The disclosure further provides processes for generating light from quantum dots comprising Group II-VI elements. The processes include applying energy to the etched quantum dots to provide excited quantum dots. Energy can be applied using e.g., heat or light. In some embodiments, the generated light has a narrower emission spectral linewidth than light generated from comparable quantum dots etched with hydrofluoric acid. The etched quantum dots can also or in addition can be shelled using techniques known in the art as described above.

### The Etched Quantum Dots

As described, the quantum dots are etched and/or shelled. The etched/quantum dots described herein also are fluorinated. In some embodiments, the quantum dots contain at least about 1% by weight, based on the weight of the quantum dot, of fluorine groups. In other embodiments the quantum dots contains about 0.1 to about 100% by weight, based on the weight of the quantum dot, of fluorine. In further embodiments, the quantum dots contains about 0.1, about 0.2, about 0.3, about 0.4, about 0.5, about 0.6, about 0.7, about 0.8, about 0.9, about 1, about 10, about 20, about 30, about 40, about 50, about 60, about 70, about 80, about 90, about 95, or 100% by weight, based on the weight of the quantum dot, of fluorine. In yet other embodiments, the quantum dots contains contain about 10 to about 90, about 10 to about 75, about 10 to about 50, about 10 to about 25, about 25 to about 100, about 25 to about 75, about 25 to about 50, about 50 to about 100, about 50 to about 75, or about 75 to about 100% by weight, based on the weight of the quantum dot, of fluorine groups.

The quantum dots can be in the form of any shape that is capable of absorbing or generating light. In certain embodiments, the quantum dot is in the shape of a sphere, rod, cube, tetrahedron, or platelet, or combination thereof. In certain aspects, the quantum dot is in the shape of a sphere. In other aspects, the quantum dot is in the shape of a rod. In further aspects, the quantum dot is in the shape of a cube. In yet other aspects, the quantum dot is in the shape of a tetrahedron. In still further aspects, the quantum dot is in the shape of a platelet.

As discussed herein the quantum dots are capable of generating light, Desirably, the quantum dots prepared as described herein have high quantum yields compared to quantum dots prepared using than HF. In certain embodiments, the quantum dots have a photoluminescence quantum yield (PLQY) of about 20 to about 100%. In further embodiments, the quantum dots have a PLQY of about 20, about 30, about 40, about 50, about 60, about 70, about 80, about 90, or about 100%. In other embodiments, the quantum dots have a PLQY of about 20 to about 75, about 20 to about 50, about 25 to about 100, about 25 to about 75, about 25 to about 50, about 50 to about 100, about 50 to about 75, or about 75 to about 100%.

### Devices, Stains, and Labels

The disclosure also provides devices, stains, or labels comprising one or more quantum dots prepared as described herein. In certain aspects, the device is a light emitting diode (LED), such as a LED that lacks Cd. In other aspects, the device is a luminescent display such as a television or microdisplay. In further aspects, the device is a light bulb. In yet other aspects, the device is a laser. In still further aspects, the device is a photodetector. In other aspects, the device is a photovoltaic cell.

### Aspects

Aspect 1. A process for preparing etched quantum dots comprising Group III-V elements, comprising:
etching Group III-V element quantum dots with an organic fluoride agent and
optionally shelling the etched quantum dots.

Aspect 2. A process for generating light from quantum dots comprising Group III-V elements, comprising:
etching the quantum dots with organic fluoride agent to form etched quantum dots;
applying energy to the etched quantum dots to provide excited quantum dots; and
optionally shelling the etched quantum dots.

Aspect 3. The process of Aspect 1 or Aspect 2, wherein the shelling is performed in the presence of one or more materials.

Aspect 4. The process of Aspect 3, wherein a material is X′—Y′, wherein X′ is a Group 12 metal and Y′ is a Group 6 element, such as ZnO, ZnS, ZnSe, CdS, CdSe, CdTe, HgS, HgSe, HgTe, or a combination thereof, or such as ZnS, ZnSe, or ZnS/ZnSe.

Aspect 5. The process of Aspect 3, wherein the material is another Group III-V element.

Aspect 6. The process of any one of the preceding Aspects, wherein the etching further comprises application of one or more surfactants.

Aspect 7. The process of any one of Aspects 2-6, wherein the applying is performed using heating or light.

Aspect 8. The process of any one of Aspects 2-7, wherein the generated light has a narrower emission spectral linewidth than light generated from comparable quantum dots etched with hydrofluoric acid.

Aspect 9. The process of any one of the preceding Aspects, wherein the organic fluoride agent is an electrophilic fluoride agent.

Aspect 10. The process of Aspect 9, wherein the electrophilic fluoride agent is N-fluorobenzenesulfonimide, an N-fluoropyridinium compound, 1-chloromethyl-4-fluoro-1,4-diazoniabicyclo[2.2.2]octane bis(tetrafluoroborate) (Selectfluor), or a 1-chloromethyl-4-fluoro-1,4-diazoniabicyclo[2.2.2]octane bis(tetrafluoroborate derivative.

Aspect 11. The process of Aspect 10, wherein the N-fluoropyridinium compound is of formula I:

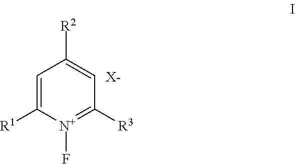

wherein:
   R¹, R², and R³ are, independently, halo or C₁₋₆alkyl; and
   X⁻ is ⁻BF₄, ⁻OTf, ⁻PF₆, or ⁻NO₃.

Aspect 12. The process of Aspect 11, wherein R¹ is halo, such as F, Cl, or Br, such as Cl.

Aspect 13. The process of Aspect 11, wherein R¹ is C₁₋₆alkyl, such as methyl, ethyl, propyl, butyl, pentyl, or hexyl, or such as methyl.

Aspect 14. The process of any one of Aspects 11-13, wherein R² is halo, such as F, Cl, or Br, such as Cl.

Aspect 15. The process of any one of Aspects 11-13, wherein R² is C₁₋₆alkyl, such as methyl, ethyl, propyl, butyl, pentyl, or hexyl, or such as methyl.

Aspect 16. The process of any one of Aspects 11-13, wherein R³ is halo, such as F, Cl, or Br, such as Cl.

Aspect 17. The process of any one of Aspects 11-13, wherein R³ is C₁₋₆alkyl, such as methyl, ethyl, propyl, butyl, pentyl, or hexyl, or such as methyl.

Aspect 18. The process of any one of Aspects 1-8, wherein the organic fluoride agent is a nucleophilic fluoride agent.

Aspect 19. The process of Aspect 18, wherein the nucleophilic fluoride agent is a sulfonyl fluoride compound, acyl fluoride, tetrahydro-1,3-dimethyl-2(1H)-pyrimidinone hydrofluoride (DMPU-HF), or triethylamine trihydrofluoride (TREAT-HF).

Aspect 20. The process of Aspect 19, wherein the sulfonyl fluoride compound is of formula IIA or IIB:

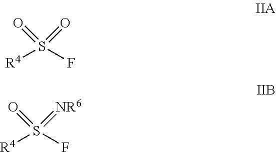

wherein:
   R¹ is H, optionally substituted C₁₋₆alkyl, optionally substituted C₂₋₆alkenyl optionally substituted heteroaryl, or optionally substituted aryl; and
   R⁶ is H or C₁₋₆alkyl.

Aspect 21. The process of Aspect 20, wherein R⁴ is H.

Aspect 22. The process of Aspect 20, wherein R⁴ is optionally substituted C₁₋₆alkyl, such as methyl, ethyl, propyl, butyl, pentyl, or hexyl, or such as methyl, benzyl, or bromomethyl.

Aspect 23. The process of Aspect 20, wherein R⁴ is optionally substituted C₂₋₆alkenyl, such as ethenyl, propenyl, butenyl, pentenyl, or hexenyl, or such as ethenyl or benzyl.

Aspect 24. The process of Aspect 20, wherein R⁴ is optionally substituted aryl such as phenyl, naphthyl, or indolyl.

Aspect 25. The process of Aspect 24, wherein R⁴ is optionally substituted phenyl such as 4-tolyl.

Aspect 26. The process of Aspect 20, wherein R⁴ is optionally substituted heteroaryl such as pyridinyl.

Aspect 27. The process of Aspect 20, wherein the sulfonyl fluoride is pyridine-2-sulfonyl fluoride (PyFluor), ethenesulfonyl fluoride, benzylsulfonyl fluoride, 4-methylbromosulfonyl fluoride, 4-tolyl-sulfonyl fluoride.

Aspect 28. The process of Aspect 19, wherein the acylfluoride is of formula

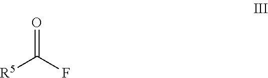

wherein, R⁵ is C₁₋₆alkyl, aryl, or heteroaryl.

Aspect 29. The process of Aspect 29, wherein R⁵ is optionally substituted C₁₋₆alkyl, such as methyl, ethyl, propyl, butyl, pentyl, or hexyl, or such as methyl, benzyl, or bromomethyl.

Aspect 30. The process of Aspect 29, wherein R⁵ is optionally substituted C₂₋₆alkenyl, such as ethenyl, propenyl, butenyl, pentenyl, or hexenyl, or such as ethenyl or benzyl.

Aspect 31. The process of Aspect 29, wherein R⁵ is optionally substituted aryl such as phenyl, naphthyl, or indolyl.

Aspect 32. The process of Aspect 32, wherein R⁵ is optionally substituted phenyl such as 4-tolyl.

Aspect 33. The process of Aspect 29, wherein R⁵ is optionally substituted heteroaryl such as pyridinyl.

Aspect 34. The process of Aspect 29, wherein the acylfluoride is benzoyl fluoride.

Aspect 35. The process of Aspect 1 or 2, wherein the fluoride agent is:

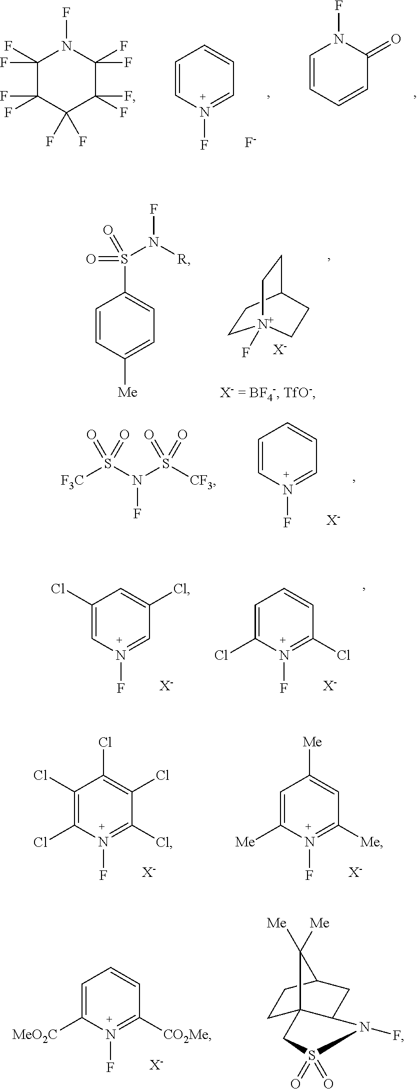

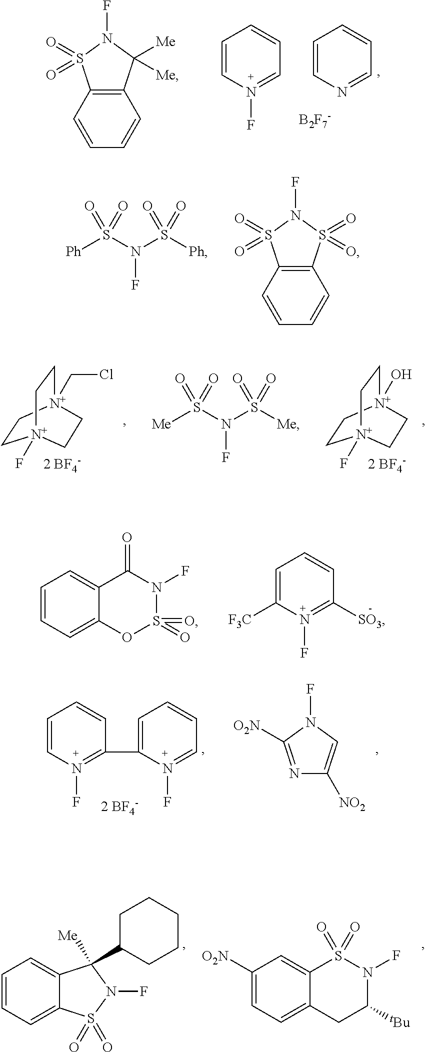

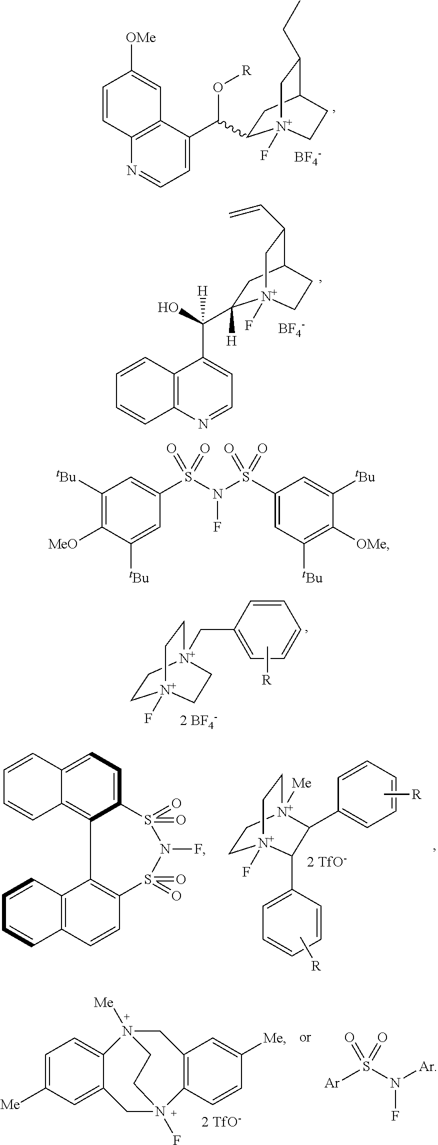

Aspect 36. The process of any one of the preceding Aspects, wherein the quantum dot comprises one or two Group III elements, or such as one Group III element, or such as two Group III elements.

Aspect 37. The process of any one of the preceding Aspects, wherein the Group III element is indium (In), gallium (Ga), aluminum (Al), or combinations thereof.

Aspect 38. The process of any one of the preceding Aspects, wherein the Group V element is phosphorus (P), arsenic (As), or combinations thereof.

Aspect 39. The process of any one of the preceding Aspects, wherein the quantum dot is GaP, InP, GaAs, InAs, InGaP, or AlP, or combinations thereof.

Aspect 40. The process of any one of the preceding Aspects, that is performed in the absence of water, oxygen, or a combination thereof.

Aspect 41. A quantum dot prepared according to the process of any one of the preceding Aspects.

Aspect 42. A device, stain, or label comprising a quantum dot prepared according to the process of any one of the preceding Aspects.

The embodiments described in this disclosure can be combined in various ways. Any aspect or feature that is described for one embodiment can be incorporated into any other embodiment mentioned in this disclosure. While various novel features of the inventive principles have been shown, described and pointed out as applied to particular embodiments thereof, it should be understood that various omissions and substitutions and changes can be made by those skilled in the art without departing from the spirit of this disclosure. Those skilled in the art will appreciate that the inventive principles can be practiced in other than the described embodiments, which are presented for purposes of illustration and not limitation.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### Example 1

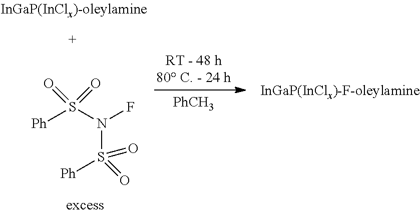 [SMILES: O=S(=O)(c1ccccc1)N(F)S(=O)(=O)c1ccccc1 ; "PhCH3"]

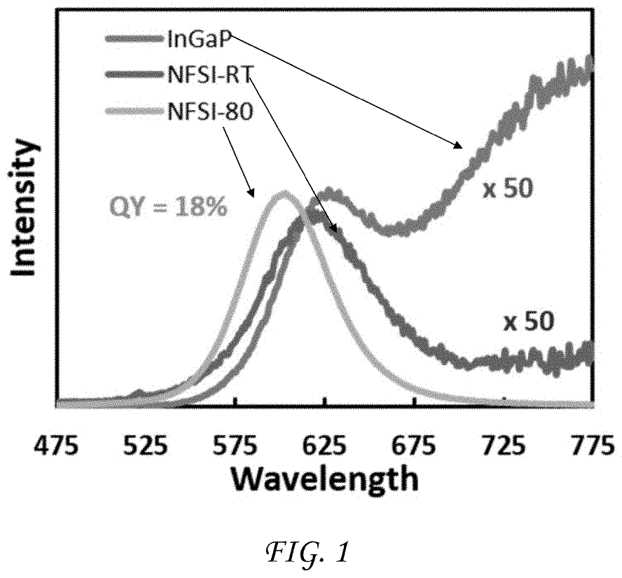

InGaP (InGa_{0.15}P_{0.8}) in toluene (0.2 mL) was diluted with toluene (1 mL). NFSI (35 mg; excess) was added and allowed to sit at room temperature in the box for 48 h. 0.2 mL of the solution was taken out to obtain a photoluminescence spectrum. Additional NFSI (20 mg) was added, the sample was then removed from the box, and heated to 80° C. for 24 h. A aliquot (0.2 mL) was diluted with toluene (2 mL) for a photoluminescence spectrum. The spectra show that the trap emission of the InGaP cores is removed and the photoluminescence quantum yield increased from <10% (unetched InGaP) to 18% after the addition of NFSI at 80° C. PLQY. See, FIG. 1.
627 nm→620 nm→603 nm

### Example 2

An InP solution was prepared as shown in the following scheme as described in Tessier, Economic and Size Tunable Synthesis of InP/ZnE (E=S, Se) Colloidal Quantum Dots,” Angew. Chem. Int. Ed., 2016, 55, 3714

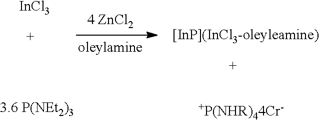

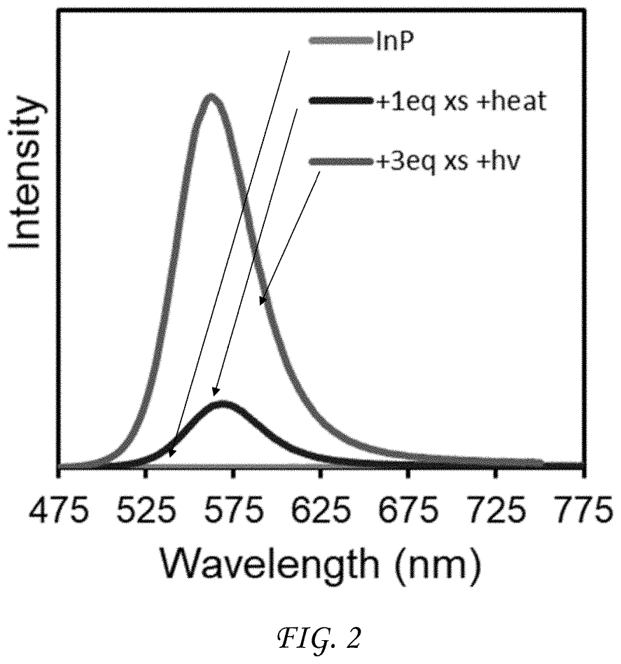

An InP solution in C₆D₆ (0.6 mL) was added to a J. young tube with benzoyl fluoride (0.094 mL) and oleylamine (0.09 mL). The sample was irradiated with 427 nm light for 24 hours. Another InP solution in C₆D₆ (0.6 mL) was added to a J. young tube with benzoyl fluoride (1 eq.) and oleylamine (0.09 mL). The sample was then heated to 80 for 12 hours. The emission spectra of unetched InP and both etched samples was obtained. See, FIG. 2. The spectra showed a photoluminescence quantum yield of about 40% from 535 nm to 517 nm.

### Example 3

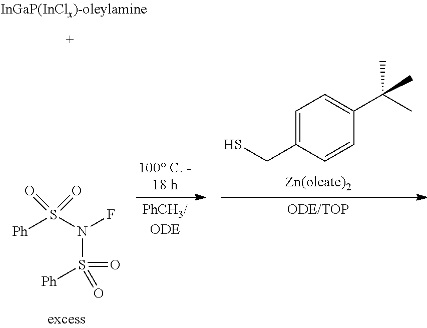

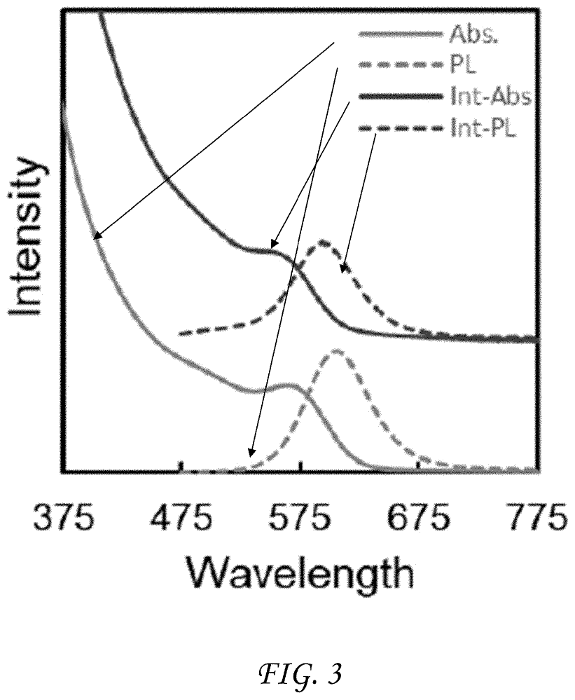

InGaP (InGa_{0.15}P_{0.8}) in toluene (0.2 mL) was treated with excess NFSI and heated to 100° C. for 18 h. This was then treated with zinc thiolate and zinc oleate. The spectrum shows a quantum yield of about 50%. See, FIG. 3.

In examples 4-15, indium(III) chloride (99.999%), zinc(II) chloride (99.999%), indium(III) acetate (99.99%), trioctylphosphine (97%) were obtained from Strem Chemicals. Benzoyl chloride (99%), tris(diethylamino)phosphine (9%), oleylamine (98%), tris(4-(trifluoromethyl)phenyl)phosphine (97%), toluene (>99.5%), methyl acetate (99%), myristic acid (99%) were purchased from Sigma-Aldrich. Tris(trimethylsilyl)phosphine (10% in hexanes) was obtained from Nippon Chemical Industrial. Benzoyl fluoride (97%), octadecene (90%) was purchased from Alfa Aesar. Anhydrous methanol (99.9%—extra dry) was obtained from Acros Organics. Benzene-d₆ (99.5%) was obtained from Cambridge isotopes lab.

All of the manipulations are in Examples 4-15 were done under inert atmosphere (nitrogen filled glovebox or Schlenk line) otherwise mentioned. Tris(trimethylsilyl)phosphine (P(TMS)₃) solution was first dried to afford pure P(TMS)₃. Oleylamine was degassed under vacuum (>0.1 mbar) at 130° C. for two hours and then stored on molecular sieves (3 and 4 Å) inside a glovebox. Deuterated solvents were distilled from CaH₂ and stored in an argon-filled glovebox on molecular sieves (3 Å). All the other chemicals were used as received.

The photoexcitation experiments in Examples 4-156 were performed using a PR160L-427 blue LED (λ_{exc}=427 nm) obtained from Kessil LED lights.

The number of moles of InP and CdS present in the following examples were determined as described in Chem. Mater. 2020, 32(10), 4358-4368; and Chem. Mater. 2017, 29(20), 8711-8719, which are incorporated by reference herein.

### Example 4: Oleylamine-Capped InP QDs Synthesis (λₗₛ₋ₗₛ=580 nm)

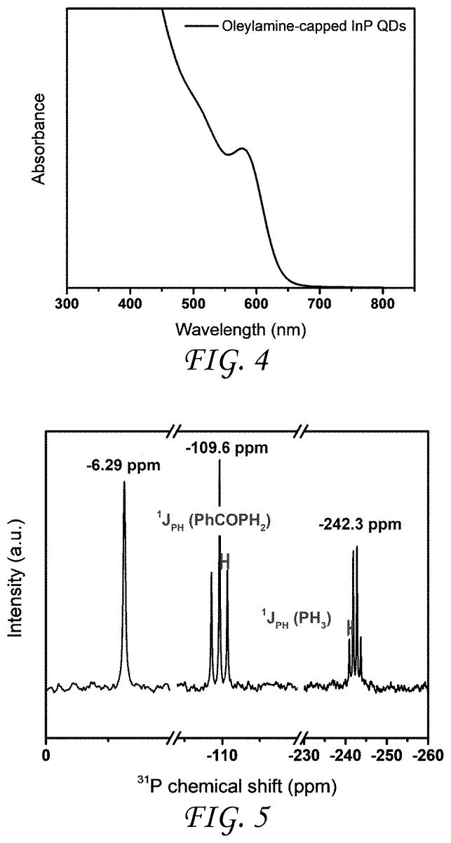

99.5 mg of indium(III) chloride (0.45 mmol-1 eq.), 306.7 mg of zinc(II) chloride (2.2 mmol-5 eq.) and 5 mL of oleylamine were loaded in a three necked round bottom flask. The temperature was then set to 185° C. and the tris(diethylamino)phosphine (0.5 mL-1.8 mmol-4 eq.) was swiftly injected in the mixture the reaction took place over 20 minutes before being cooled to room temperature. Then, the dots were washed twice using a mixture of toluene and ethanol. They were then dried and stored in a nitrogen filled glovebox. See, FIGS. 4, 33, and 35A.

### Example 5: Oleylamine-Capped InP QDs Synthesis (λₗₛ₋ₗₛ=545 nm)

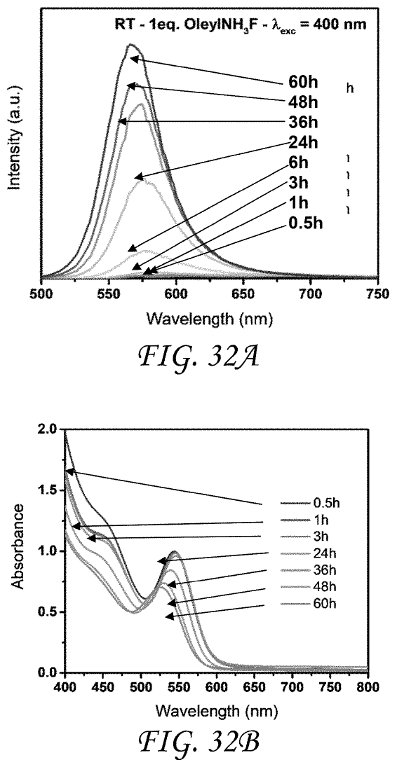

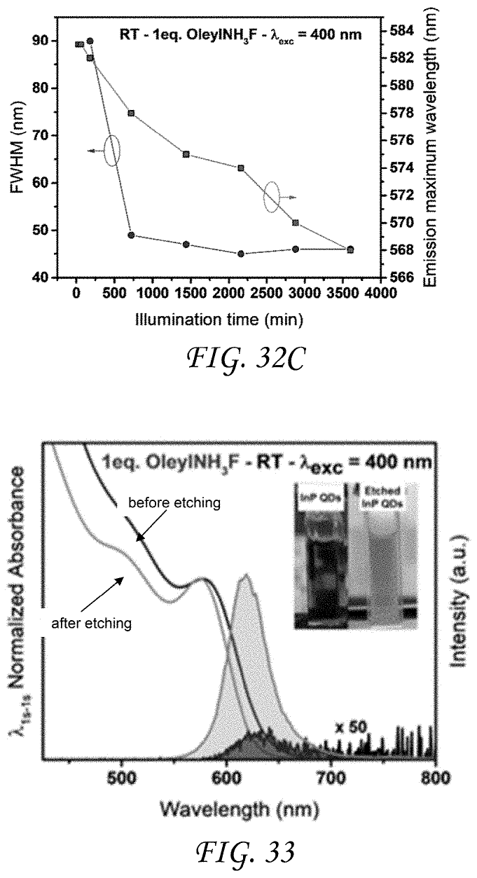

99.5 mg of indium(III) chloride (0.45 mmol-1 eq.), 306.7 mg of zinc(II) chloride (2.2 mmol-5 eq.) and 5 mL of oleylamine were loaded in a three necked round bottom flask. The temperature was then set to 150° C. and the tris(diethylamino)phosphine (0.5 mL-1.8 mmol-4 eq.) was swiftly injected in the mixture the reaction took place over 20 minutes before being cooled to room temperature. Then, the dots were washed twice using a mixture of toluene and ethanol. There were then dried and stored in a nitrogen filled glovebox. See, FIG. 32B.

### Example 6: Myristate-Capped InP QDs Synthesis (λₗₛ₋ₗₛ=580 nm)

Given the line narrowing described above, the reaction between [F]⁻[H₃N—R]⁺ and InP QDs synthesized from indium myristate ligands, which typically display narrower spectral features than QDs made from InCl₃ and aminophosphines was studied. See, e.g., Ramasamy, Chemistry of Materials 2018, 30 (11), 3643-3647.

A. Summary

These dots were synthesized using a seeded-growth method. The seed synthesis was adapted from the method of Ramasamy, Chemistry of Materials, 2018. 30(11): p. 3643-3647. 58.4 mg of indium(III) acetate (0.2 mmol-2 eq.), 137 mg of myristic acid (0.6 mmol-6 eq.) and 7 mL of octadecene were loaded in a three necked round bottom flask. The mixture was degassed 1.5 h at 120° C. under dynamic vacuum. The mixture was cooled to room temperature, 1 mL of trioctylphosphine and P(TMS)₃ (25.1 mg-0.1 mmol-1 eq.) in octadecene (1.6 mL) were injected in the indium(III) myristate solution. The temperature was then set to 270° C. and hold for 5 min before being cooled down to room temperature.

The growth solution was prepared as follows: 160.6 mg of indium(III) acetate (0.55 mmol-5.5 eq.) and 376.8 mg of myristic acid (1.65 mmol-16.5 eq.) are mixed in a three necked round bottom flask, connected to a Schlenk line and degassed at 120° C. during 12 h. Then the mixture was cooled to room temperature and 68.9 mg of P(TMS)₃ (0.275 mmol-2.75 eq.) dissolved in 0.4 mL of octadecene are added to the mixture.

The growth mixture is then injected in the seeds suspension (addition rate: 0.1 mmol·h⁻¹) at 280° C. When the growth solution is fully added to the seeds the reaction is cooled to room temperature. The resulting QDs are then transfer into a nitrogen filled glovebox and purified using a mixture of methyl acetate and toluene. InP QDs are resuspended in 2 mL of toluene and stored under inert atmosphere.

B. Results

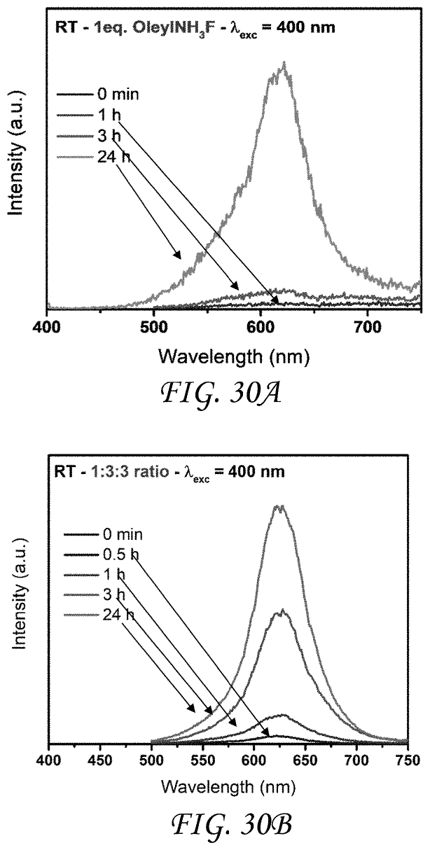

Interestingly, one equivalent of [F]⁻[H₃N—R]⁺ had a minor influence on the PLQY and UV-Vis spectrum (FIG. 30A). Etching with benzoyl fluoride and substoichiometric oleylamine (FIG. 30B) proved more reactive, further blue shifting the spectra and increasing in PL, although substantial broadening of the optical spectrum was again observed. To determine whether the decreased reactivity of these QDs resulted from their carboxylate ligands, the native myristate ligands were cleaved using chlorotrimethylsilane (Cl—SiMe₃).

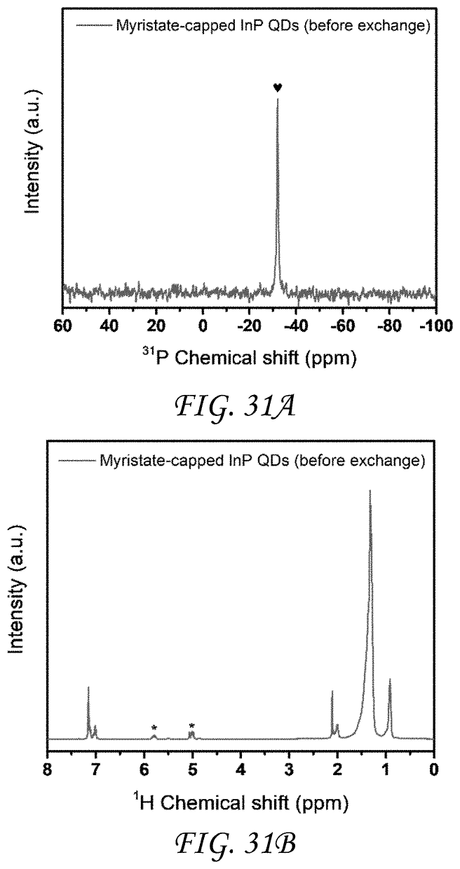

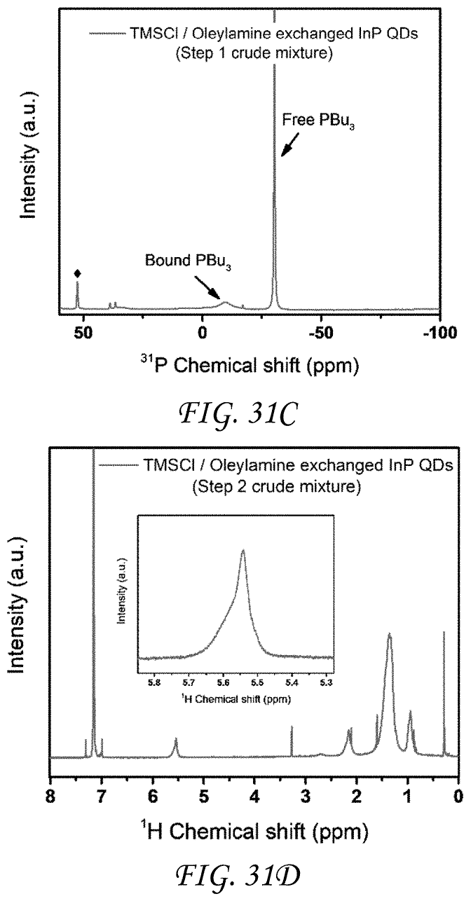

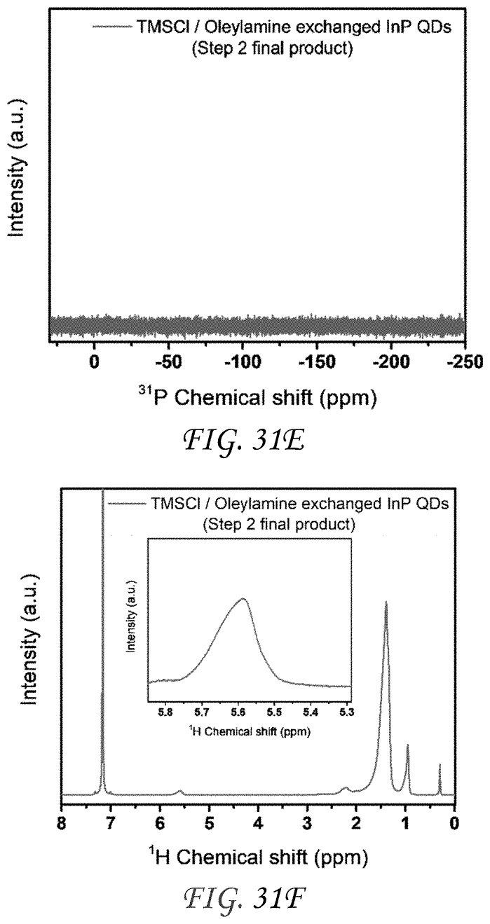

Addition of tri-n-butylphosphine and Cl—SiMe₃ to InP QDs liberated the expected myristate trimethylsilyl ester byproduct and resulted in QDs with associated tri-n-butylphosphine ligands and characteristically broadened ¹H and ³¹P NMR signals (FIG. 31). Subsequent displacement of tri-n-butylphosphine ligands occurred upon addition of oleylamine, providing colloidally stable InP nanocrystals with oleylamine ligands. See, e.g., Anderson, Journal of the American Chemical Society 2018, 140, 7199-7205. These QDs were then exposed to [F]⁻[H₃N—R]⁺ according to optimized conditions as described in Examples 7, 13, and 15, which caused etching, narrowing of the photoluminescence spectrum from FWHM to 46 nm, and an increase in the PLQY (FIG. 32). The results are similar to QDs prepared from InCl₃, tris-(diethylamino)phosphine and oleylamine. It was found that the myristate ligands are responsible for the decreased reactivity toward etching, perhaps because of their increased basicity relative to chloride, the greater stability of the in-carboxylate bond, or the presence of oxides present from the synthesis that are removed upon reaction with chlorotrimethylsilane.

### Example 7: Etching Procedure

The quantities needed for etching with 1 eq. of oleylNH₃F are given as an example. In a nitrogen filled glovebox, 3 mL of a InP QDs suspension (≈2.7.10-3 mol·L⁻¹) is loaded in a screw capped quartz cuvette. Oleylamine (32 μL-[oleylamine]=0.5 M) and benzoyl fluoride (16 μL-[benzoyl fluoride]=0.5 M) are sequentially injected into the cuvette. The cuvette is then shaken for few seconds, sealed under nitrogen and placed in the illumination chamber under blue-light excitation (P_{LED}=352 mW·cm⁻²-λ_{etching}=427 nm) for 0 to 24 h. The QDs are then washed using a mixture of methyl acetate and toluene (3×) in a glovebox and resuspended in 2 mL of toluene or C₆D₆. See, FIG. 33.

### Example 8: Ligand Exchange on Myristate-Capped InP QDs

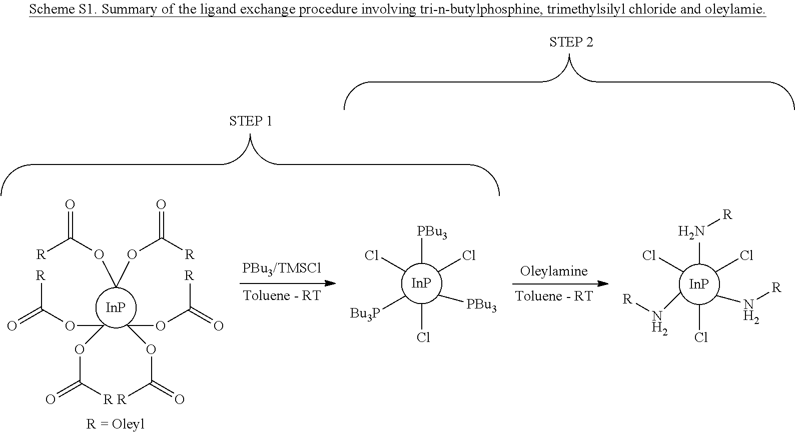

The ligand exchange procedure has been adapted from Anderson, Journal of the American Chemical Society, 2018. 140: p. 7199-7205. For the step 1. In a glovebox, myristate-InP and toluene (1 mL) are added to a 20 mL vial equipped with a stir bar. To this, trimethylsilyl chloride (26 mg, 0.24 mmol) and tri-n-butylphosphine (101 mg, 0.50 mmol) are added, the vial is then sealed and left to stir for 12 hours, yielding InP—Cl/PBu₃ nanocrystals. Then for step 2, oleylamine (133.8 mg, 0.5 mmol) is added to the InP—Cl/PBu₃ nanocrystals in toluene (3 mL) and stirred overnight. The nanocrystals were purified through precipitation/resuspension cycles (×5) using methyl acetate (or ethanol) and toluene. The sample is dried in vacuo and dissolved in 0.5 mL benzene-d₆ for NMR characterization. See, FIG. 31A-31F.

### Example 9: InP/ZnS and InP/ZnSe/ZnS QDs Synthesis

The development of Cd-free quantum for LED and display devices is of great interest, the deposition of a ZnS shell on InP-based core seems to be necessary in order to achieve good photostability under operating conditions (continuous UV/blue excitation, variable temperatures, etc.).

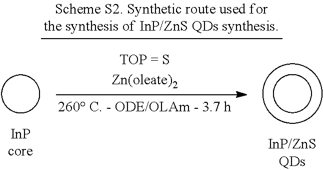

The synthesis of oleylamine-capped InP QDs is performed as described above. However, instead of purifying the QDs, the crude mixture was maintained at 185° C., and 0.4 mL of sulfur dissolved in trioctylphosphine (2.24 M), was added to the InP-core suspension. The mixture was allowed to react for 2 h at 185° C. Then a zinc oleate solution was added (1.5 g of zinc oleate in 4 mL of octadecene (ODE) and 2 mL of oleylamine (OLAm)), and the temperature was set to 260° C. Once the temperature reached 200° C., 1.4 mL of tri-n-octylphosphine sulfide (TOP=S in Scheme S2 and S3) (2.24 M) was added dropwise over 10 min. The mixture reacted at 260° C. for 1.7 h. Then the purification steps and the storage procedure were performed in the same way as for the InP cores.

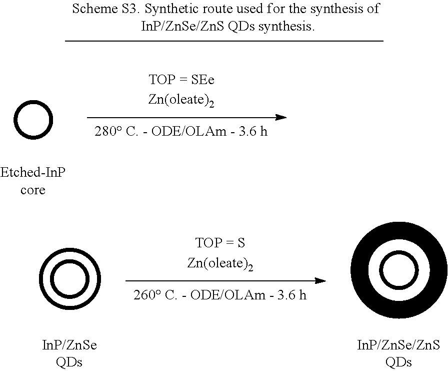

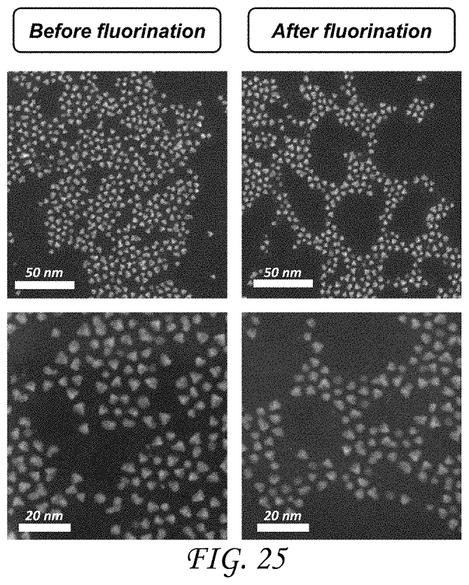

ZnS QDs were synthesized after adaptation of existing procedures. See, e.g., Brodu, The Journal of Physical Chemistry Letters 2019, 5468-5475. FIG. 37 presents the evolution of the optical properties of InP/ZnS before and after surface passivation using 1 equivalent of in situ generated [F]⁻[H₃N—R]⁺. Optical properties of InP/ZnS are drastically increased thanks to the surface treatment, the quite low starting PLQY (33%) is increased to 82% after two hours of surface fluorination. The STEM images support the hypothesis of surface fluorination of InP/ZnS QDs since no alteration of the shape and size distribution is perceptible (FIG. 25).

### Example 10: Amine Screening

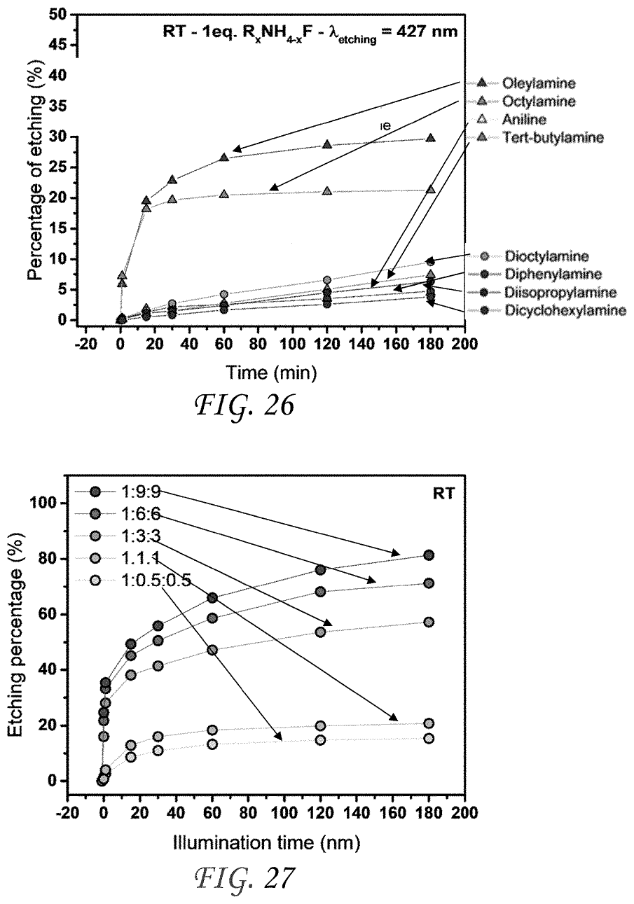

The etching method has been used with different amines. Secondary (dioctylamine, diisopropylamine, dicyclohexylamine and diphenylamine) and primary (oleylamine, tert-butylamine and aniline) amines have been studied. Several results are presented in FIG. 26.

Due to their low basicity, aniline and diphenylamine are expected to favor the protonation step of InP QDs, thus increasing the release rate of PH₃. However, because of the nitrogen lone pair delocalization—that lower their nucleophilicity—and their steric hindrance, these amines are not subject to efficiently react in favor of the conversion of benzoyl fluoride. In the same way, despite dioctylamine and dicyclohexylamine are a better nucleophile, their steric hindrance doesn't allow it to be a good co-etchant molecule. Same conclusion is made for tert-butylamine.

Oleylamine and octylamine appear to be a good compromise in terms of basicity and steric hindrance, for the further experiments, oleylamine has been selected.

These results demonstrate that primary amines lead to more rapid cleavage of the C—F bond.

### Example 11: Sub-Stoichiometric Etching Conditions

Different ratios were assessed in order to study the effect of a sub-stoichiometric amount of oleylamine on the etching process of the InP QDs. The ratio are done according to this notation: (InP)ᵢ:benzoyl fluoride:oleylamine.

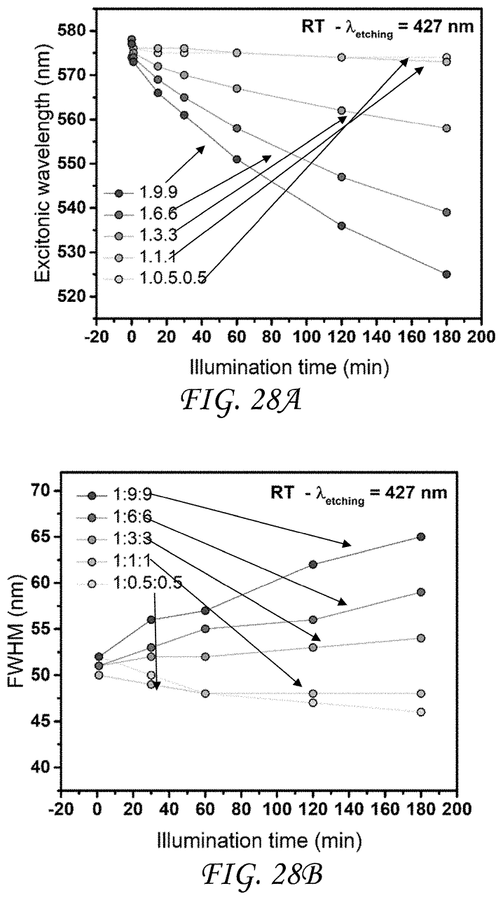

As shown in FIG. 27, the more oleylamine and benzoyl fluoride added caused an increase in the etching rate, thereby yielding to an uncontrolled etching of the QDs. This effect is accompanied by a systematic blueshift of both the emission and the absorption wavelengths (FIGS. 28A and 28B). Moreover, a quasi-systematic increase in the FWHM of the emission is observed. This highlights the poor control over the etching kinetics allowed by the sub-stoichiometric conditions employed. At low ratio (i.e., 1:0.5:0.5 and 1:1:1) a minor decrease of the FWHM is noticed (from 51 to 46(7) nm), meaning that the etching is more controlled.

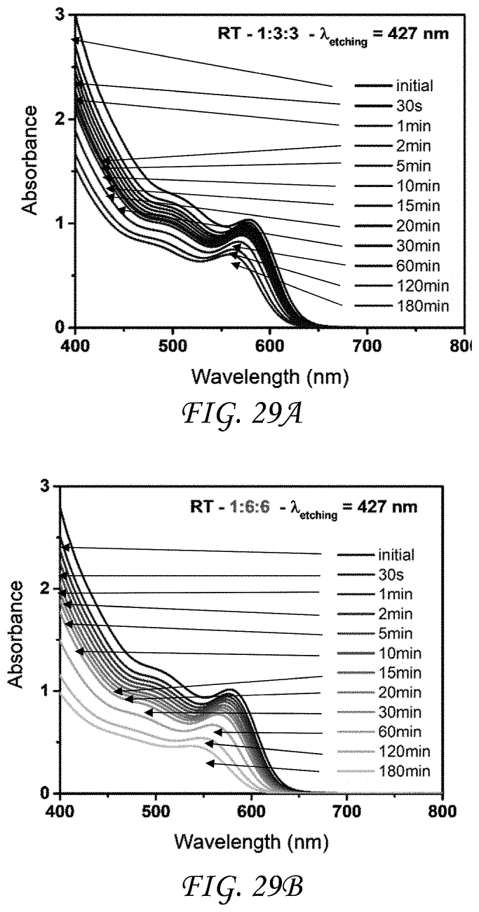

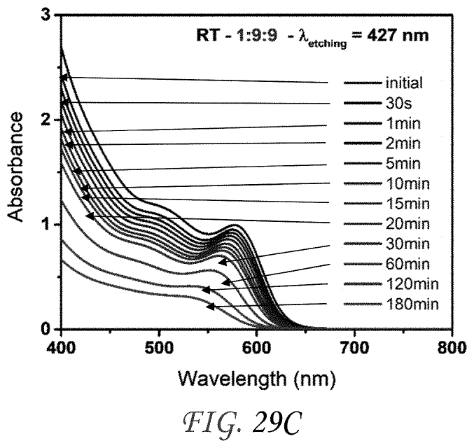

This conclusion can also be formulated according to the study of the evolution of the UV-Vis spectra. Indeed, due to the increase of the size distribution, the excitonic transition becomes less well-defined. See, FIGS. 27, 28A, 28B and 29A-29C.

### Example 12: Carboxylate Terminated CdS/CdSe/CdS QWs

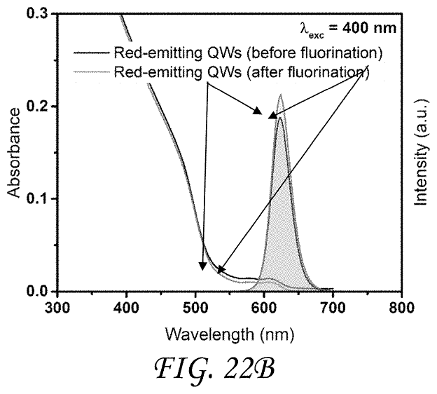

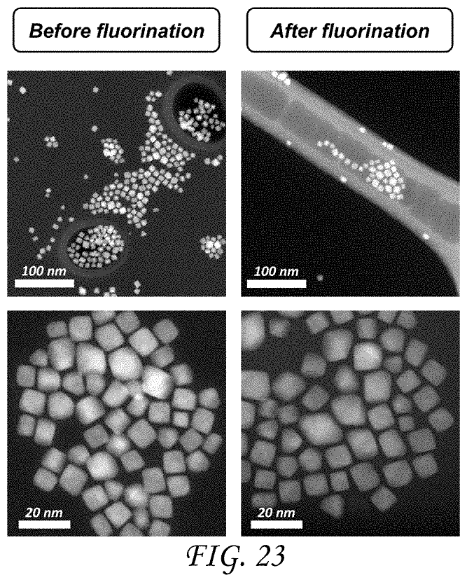

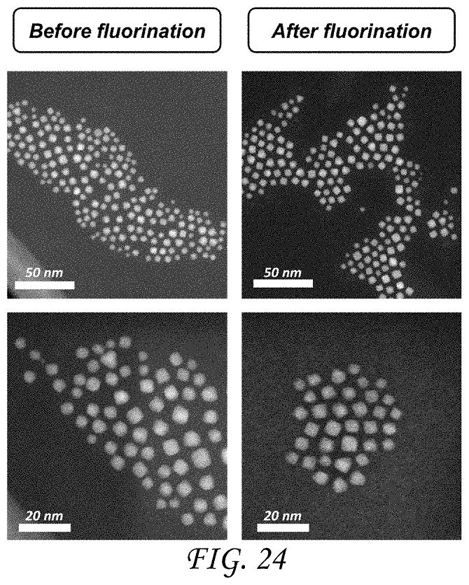

Carboxylate terminated CdS/CdSe/CdS QWs were synthesized as described and then treated following the same procedure as presented above. The QWs were treated using 1 equivalent of [F]⁻[H₃N—R]⁺. As shown, on FIG. 22A, no changes have been noticed on the UV-Vis spectra after 3 h, only a PL intensity increase and a slight line narrowing are highlighted. The PLQY is also enhanced from 88% up to near-unity (˜97%). The PLQY of small QWs also increases (from 65 to 82%) after the fluorination treatment (FIG. 22B). For both QWs sizes no alteration of either their shape and size distribution (FIGS. 23 and 24). These effects are assumed to be due to the surface passivation effect allowed by the fluoride ions present in solution.

### Example 13

As described herein, the reaction of InP and II-VI QDs with anhydrous oleylammonium fluoride ([F]⁻[H₃N—R]⁺) produced from benzoylfluoride and oleylamine according to Scheme 1 was analyzed.

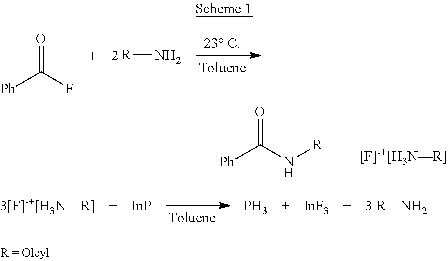

A stoichiometry of 2 to 1 leads to the production of oleylbenzamide and [F]⁻[H₃N—R]⁺ as can be seen using ¹H and ¹⁹F NMR spectroscopy. The anhydrous [F]⁻[H₃N—R]⁺ was then used to etch the surfaces of tetrahedral InP QDs prepared from InCl₃ and P(NEt₂)₃ exhibiting a well-defined excitonic transition at 583 nm (FIG. 33). See, e.g., Tessier, Chemistry of Materials 2015, 27 (13), 4893-4898. Treating these QDs with 1 equiv. of [F]⁻[H₃N—R]⁺ with respect to the concentration of InP units causes a slow etching of the QD that could be accelerated by warming the mixture above room temperature or irradiation using a 399 mW/cm² Kessil lamp (λₘₐₓ=427 nm). A steady increase and blue shift in the band edge photoluminescence is accompanied by narrowing of the spectral features (FIG. 33). Together with a decrease of the absorbance at high energy (λ=413 nm), it is concluded that these changes result from etching of the InP lattice and shrinking of the QD size.

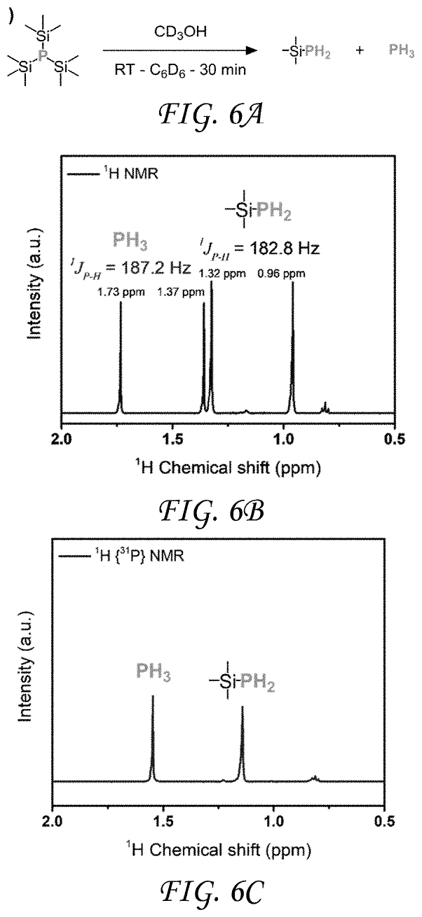

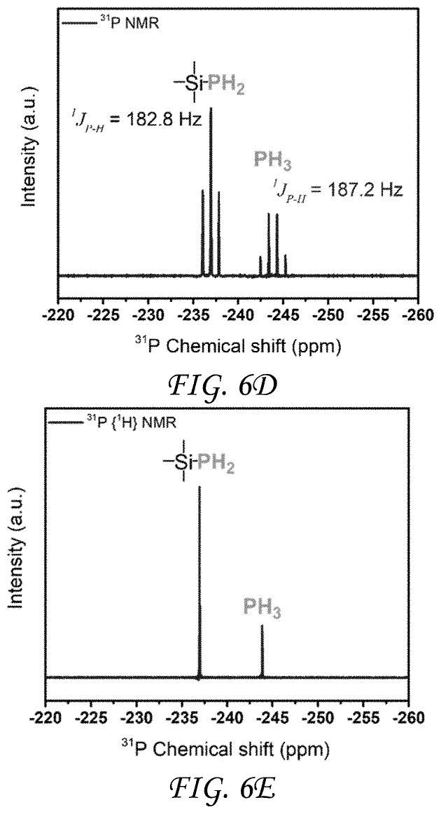

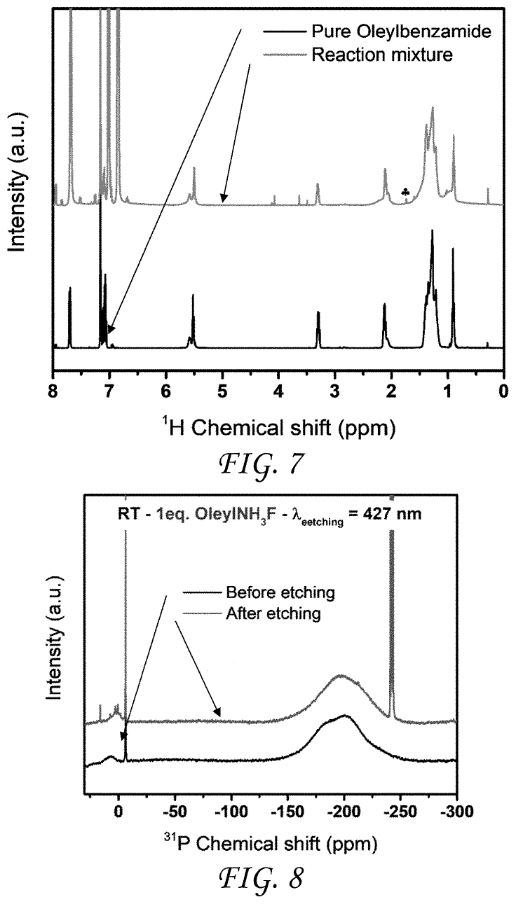

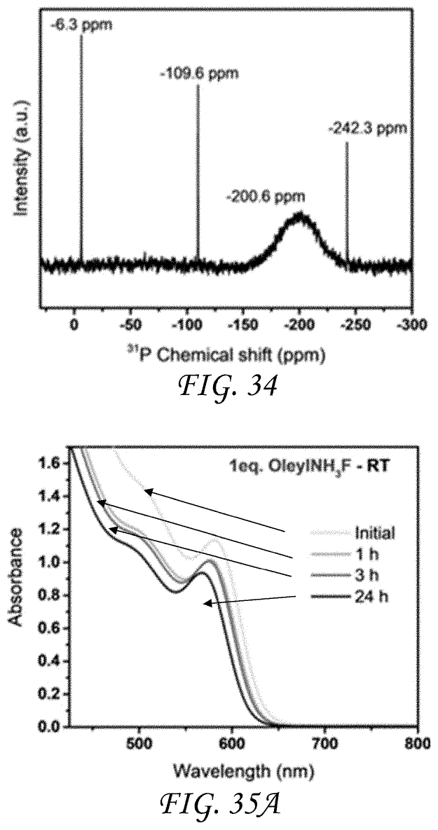

³¹P NMR spectroscopy was also used to monitor the etching process (FIG. 8). Before the etching treatment, two features corresponding to InP (δ=−200 ppm) and a signal that has been assigned to POx species (δ=6 ppm) and are visible. See, e.g., Tessier, Chemistry of Materials 2018, 30 (19), 6877-6883; Hanrahan, Journal of Physical Chemistry C 2021, 125 (5), 2956-2965. Upon reaction with [F]⁻[H₃N—R]⁺ the a sharp molecular coproduct is formed near Δδ=−109.6 ppm, that has previously been assigned to a POx moiety. In addition, signals from benzoylphosphine (δ=−109.6 ppm), phosphine (PH₃) (δ=−242.3 ppm) are observed along with the broad signal of InP QDs (δ=−200.6 ppm) (FIG. 34). See, e.g., Kieser, Chemical Communications 2017, 53 (37), 5110-5112; Rothfelder, Angewandte Chemie—International Edition 2021, 60 (46), 24650-24658; Scott, Nature Chemistry 2021, 13 (5), 458-464. Proton-coupled ³¹P NMR spectra (FIG. 5) confirm the expected number of attached hydrogens and match the reported chemical shifts and coupling constants (1JP-H (PH₃)=187.2 Hz; 1JP-H (PhC(O)PH₂)=218.3 Hz). See, e.g., Liotta, Tetrahedron letters 1984, 25 (12), 1249-1252. Garbacz, Phys. Chem. Chem. Phys. 2014, 16, 21559. Kuhl, Phosphorus-31 NMR Spectroscopy; 2008. ¹H NMR spectra confirmed the presence of PH₃ (δ=1.73 ppm, 1JP-H=187.2 Hz) and benzoylphosphine coproducts (FIGS. 6 and 7). XPS analyses confirmed the presence of an inorganic fluoride consistent with InF3 (485.4 eV). However, unlike previous reports with InP synthesized from indium myristate, no changes to the P signals were observed. The presence of fluorine in the sample is also confirmed by EDX analysis (FIG. 15). All these observations are in line with a surface passivation of the surface indium atoms by fluoride ions. However, the production of PH₃ as a coproduct is distinct from previous proposals that photoexcitation leads to reaction between fluoride and lattice phosphorus atoms.

Under the optimized conditions studied here, the benzoylphosphine coproduct is a minor species. However, conditions that are substoichiometric in oleylamine produce greater quantities of benzoylphosphine. This can be rationalized by the reaction between PH₃ and benzoyl fluoride which produces an equivalent of HF and the observed benzoylphosphine. The generation of HF can in turn react with InP, producing additional equivalents of PH₃. Thus, an HF catalyzed reaction between InP and benzoyl fluoride can be initiated by oleylamine. Under these conditions the active etchant can be oleylammonium bifluoride rather than olelyNH₃F.

### Example 14

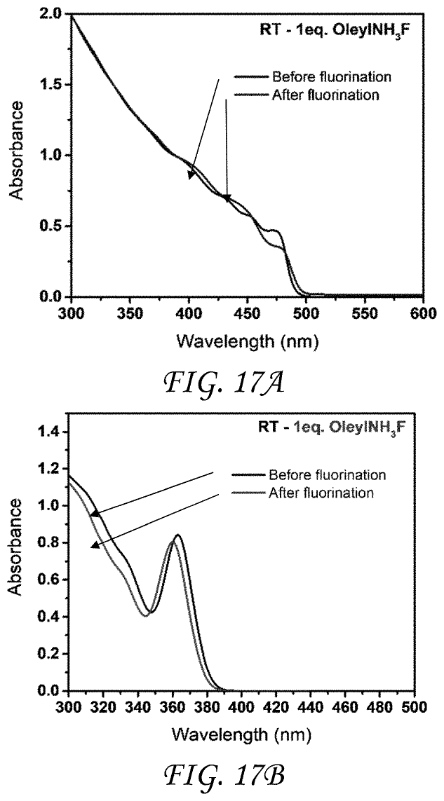

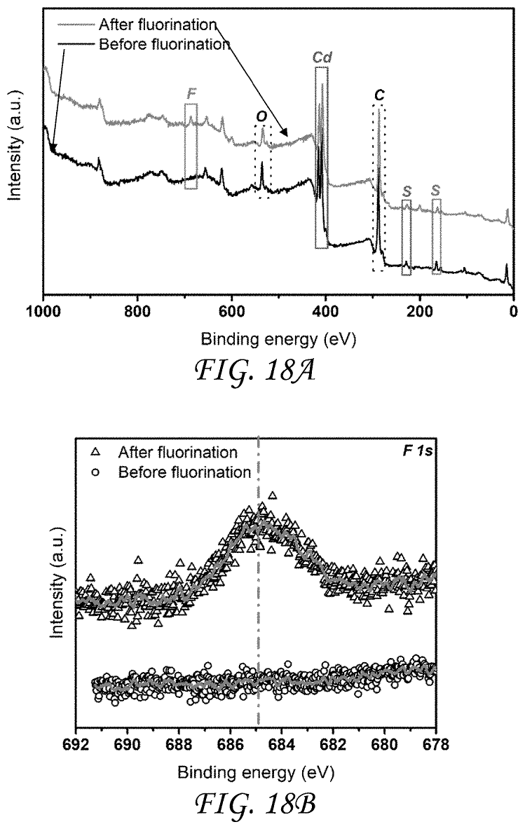

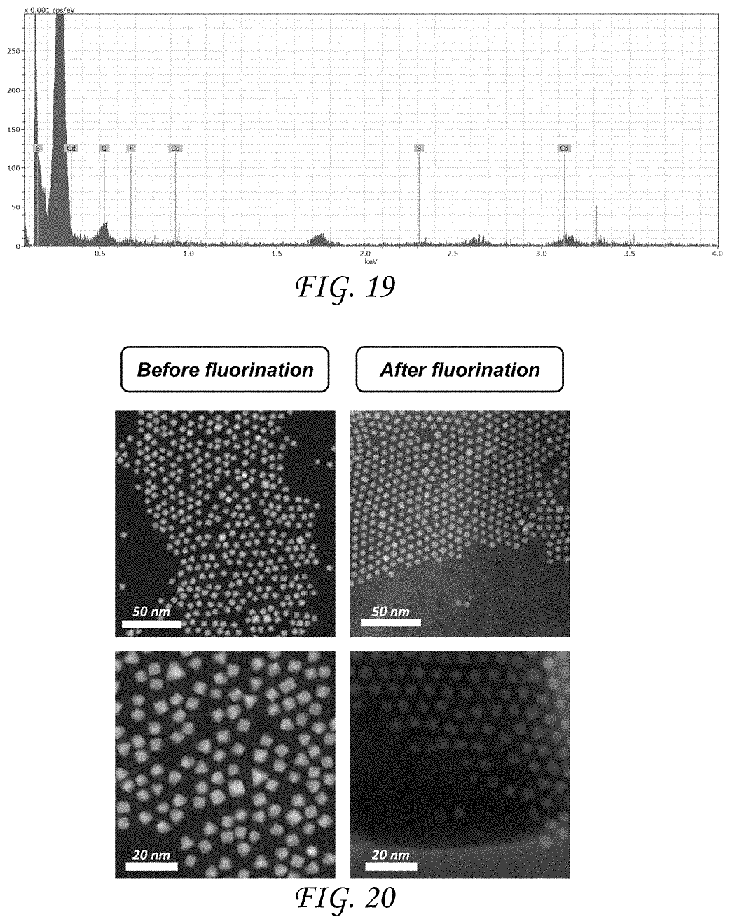

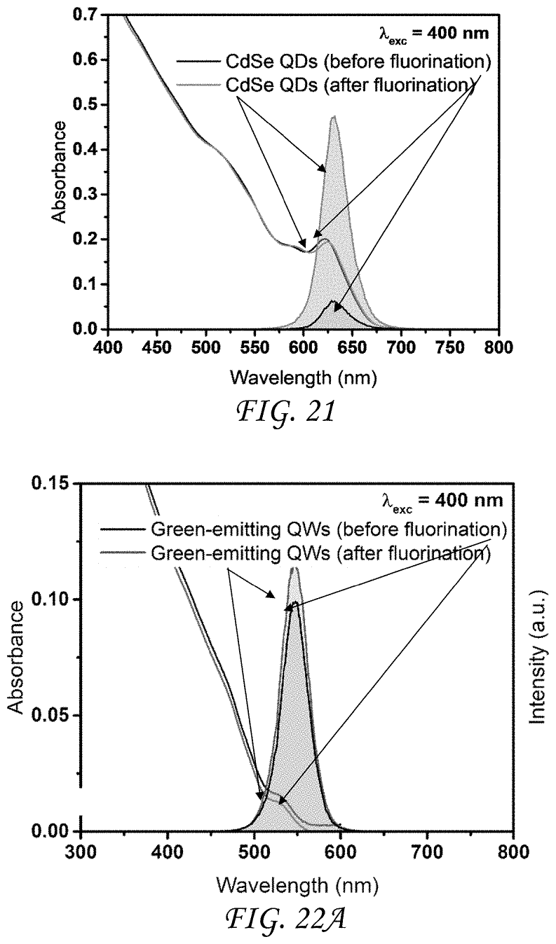

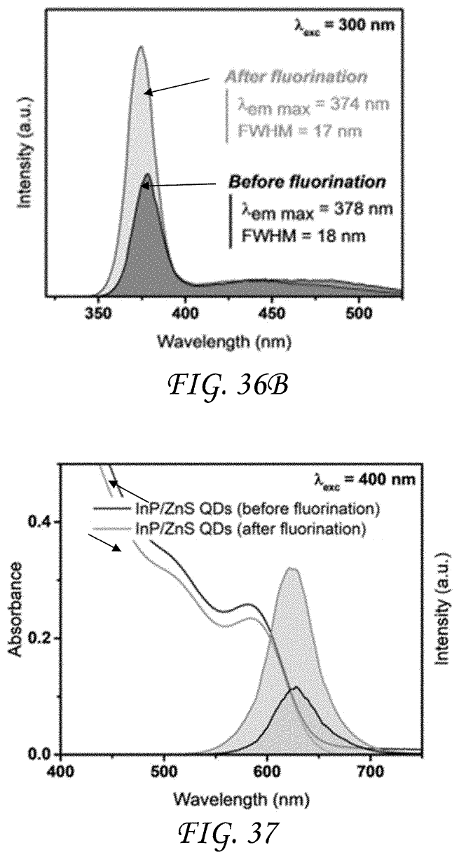

The narrowing of the photoluminescence and the increase in the PLQY observed for III-V QDs led to attempt similar treatments on II-VI QDs and heterostructures with II-VI shells. CdS, CdSe and ZnSe QDs synthesized from metal oleate and chalcogenourea precursors were exposed to [F]⁻[H₃N—R]⁺ under conditions optimized above. See, Hamachi, Chemical Science, 2019, 10 (26), 6539-6552; Hamachi, Chemistry of Materials, 2017, 29 (20), 8711-8719. In all cases, the reaction of QDs with [F]⁻[H₃N—R]⁺ increases the PLQY and eliminates the broad emission from self-trapped excitons, without significantly changing the total absorption or substantially shifting the luminescence wavelength. A summary of the optical properties are shown in Table 1. See, FIGS. 17A, 20, and 36A.

XPS analysis of CdS QDs isolated following reaction with [F]⁻[H₃N—R]⁺ (FIG. 18) shows the presence of a peak at 684.9 eV which is consistent with the presence of CdF₂. See, e.g., Nefedov, Zh. Neorg. Khimii 1974, 19, 1166. It was found that exposure of the QDs to [F]⁻[H₃N—R]⁺ results in a ligand exchange reaction and improved surface passivation that dramatically increases the PLQY of the QDs achieving record PLQY values for CdS and ZnSe core only QDs from 2 to ˜80%. Similarly, the improved surface passivation increased the PLQY of core shell QDs, including CdS/CdSe/CdS spherical quantum wells and InPZSe/ZnS and InP/ZnS core shell QDs, all of which approach unity quantum yields following ligand exchange using 1 equiv. of [F]⁻[H₃N—R]⁺. However, the PLQY of CdS/CdSe/CdS/ZnS spherical quantum wells optimized for solid state lighting were not meaningfully influenced by reaction with [F]⁻[H₃N—R]⁺.

### Example 15

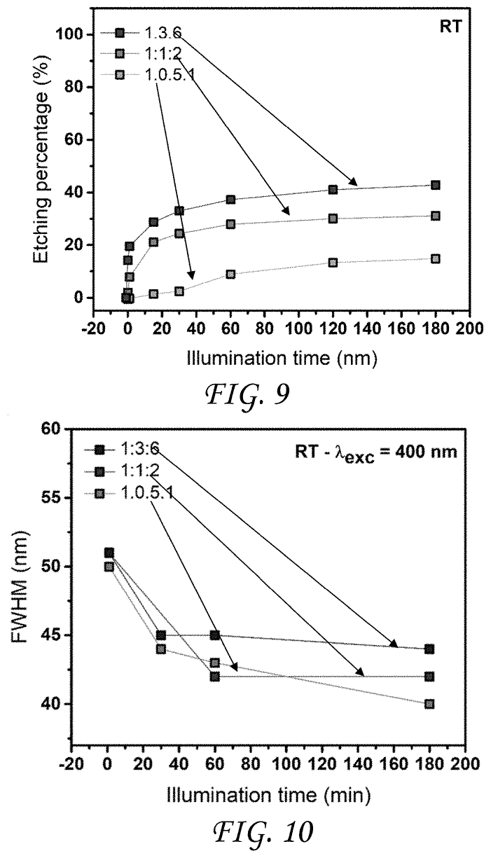

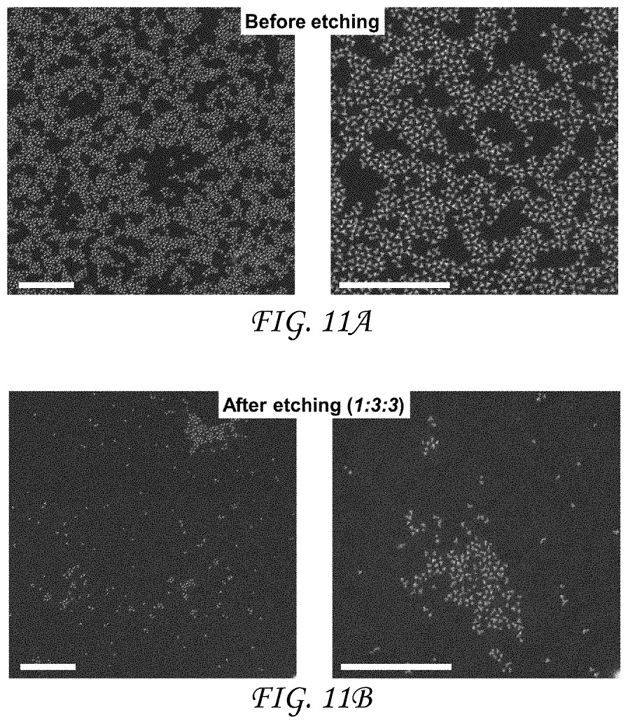

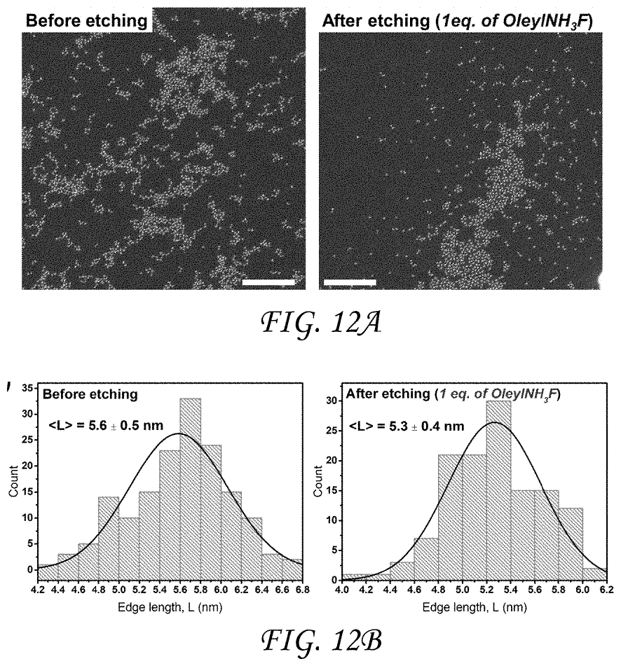

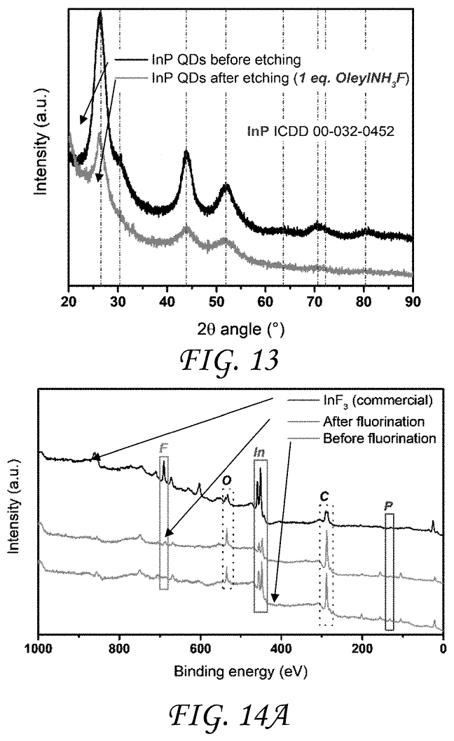

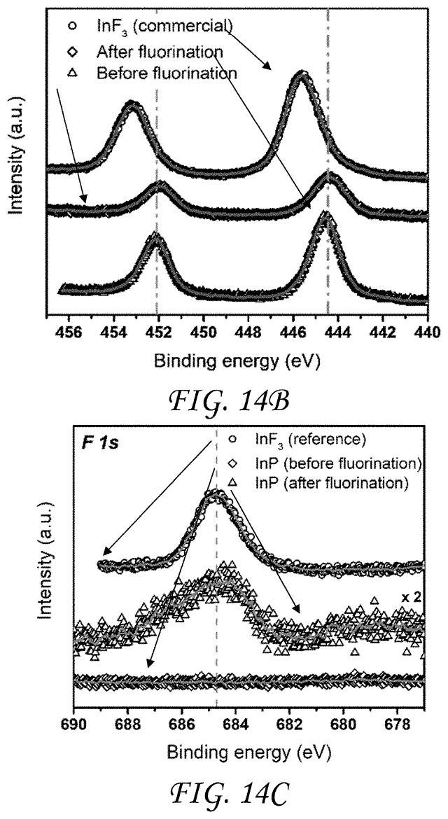

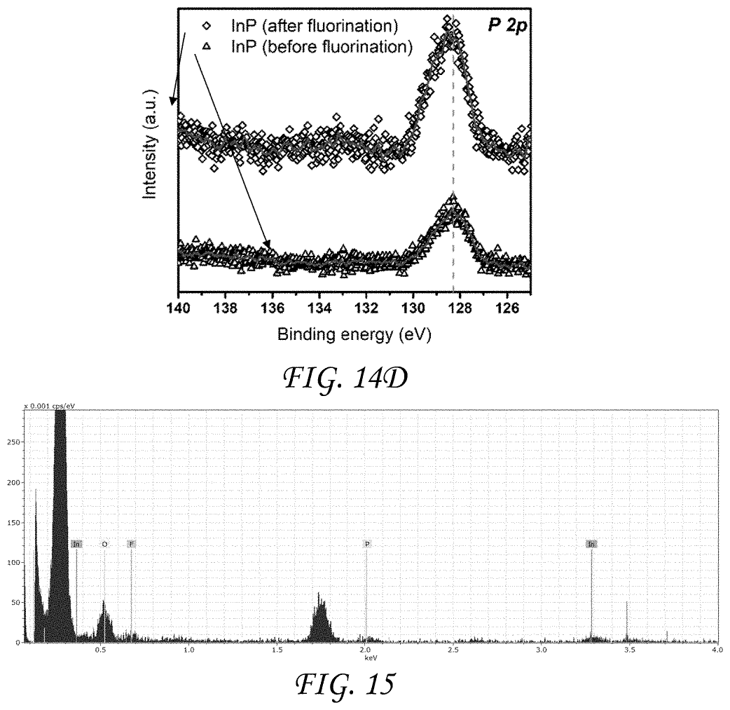

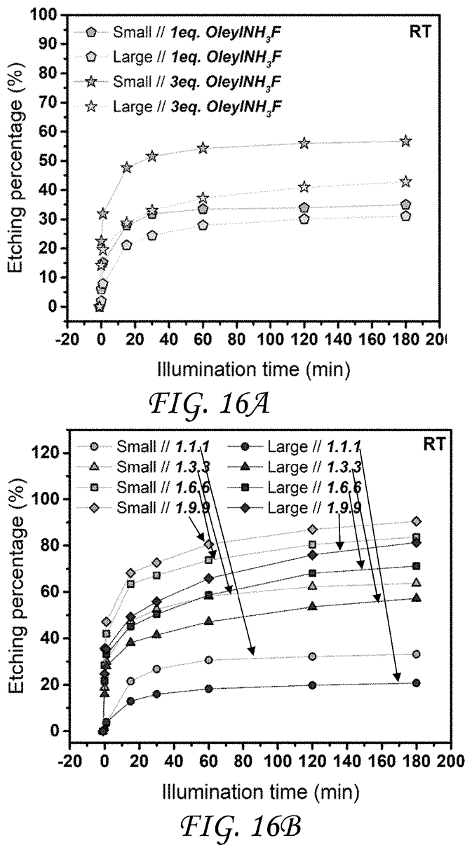

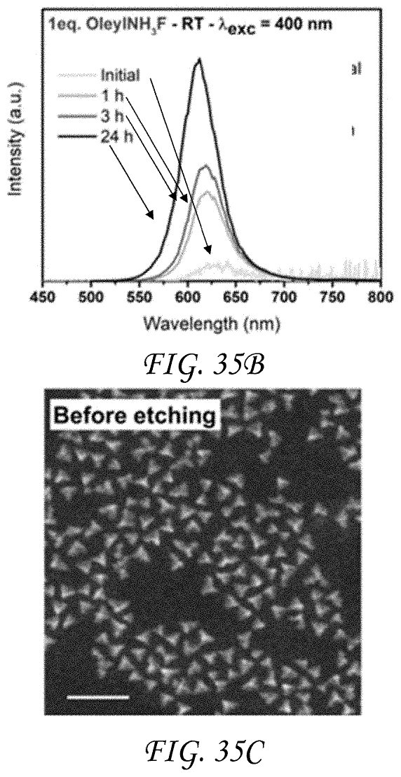

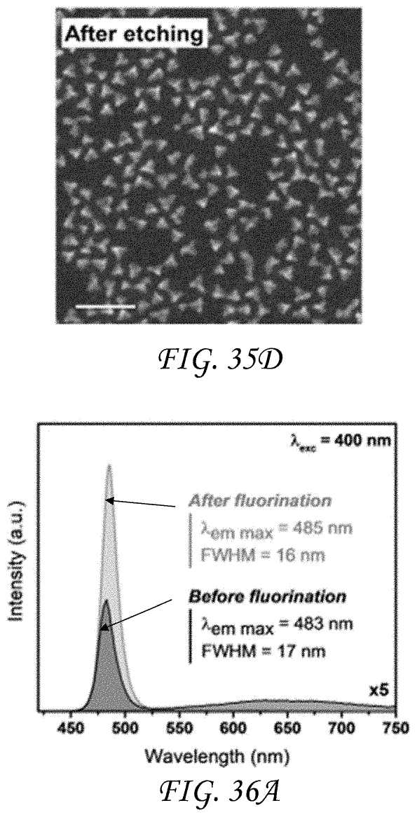

The influence of the reaction stoichiometry on the kinetics the etching reaction were explored by using absorption and photoluminescence spectroscopies (FIGS. 9 and 10). While additional equivalents of [F]⁻[H₃N—R]⁺ increase the rate and the extent of etching, this approach can broaden the photoluminescence linewidth. Etching reactions that use lower quantities of [F]⁻[H₃N—R]⁺ causes a substantial narrowing of the photoluminescence linewidth. For example, 1 equivalent of [F]⁻[H₃N—R]⁺ per InP unit causes a reduction of the FWHM from >50 to 42 nm (FIGS. 35A and 35B) and an increase in the PLQY to 50%. Further reduction in the amount of [F]⁻[H₃N—R]⁺ did not further improve the PLQY nor the FWHM. Under slow and controlled etching conditions, the tetrahedral shape, size, and polydispersity of the QDs is maintained (FIGS. 35C and 35D). The reduction of the edge length observed (Δr=0.3 nm—FIGS. 12A and 12B) agrees with the change expected from magnitude of the spectral blue shift (Δr=0.2 nm).

The changes in the photoluminescence linewidth can be attributed to elimination of broad trap luminescence commonly observed with InP QDs, however, the size dependence of the etching reactivity was analyzed to determine whether etching was accompanied by size distribution focusing. Several sizes of InP QDs and different capping ligands were studied, providing clear evidence that small InP QDs (λₗₛ₋ₗₛ=540 nm) undergo more rapid reaction with large InP QDs (λₗₛ₋ₗₛ=583 nm) under otherwise identical conditions. While it is unclear whether the magnitude of this difference is sufficient to explain the polydispersity changes, more rapid reaction of smaller QDs could lead to increased polydispersity, contrary to the narrowing observed herein. Hence, the narrowing reported herein results from a decrease of trap luminescence to the overall spectral linewidth rather than a result of size focusing.

However, HF generated from InP, benzoyl fluoride, and substoichiometric oleylamine caused substantial spectral broadening and an increase in the size distribution (FIGS. 11A and 11B). Despite the spectral broadening, the PLQY increases with the extent of etching, reaching as high as 83% at 3 eq. of added [F]⁻[H₃N—R]⁺ per unit of InP. This may be higher than any previously reported PLQY for an InP QD without a shell. The results suggest that the lower reactivity of [F]⁻[H₃N—R]⁺ as an etchant helps to improve the selectivity of the etching process, thereby preserving the polydispersity.

### Example 16: Summary

Passivation of QD surfaces upon carboxylate for fluoride ligand exchange is a straightforward and powerful method to passivate the surfaces of a variety of QDs. The effect of the fluorination on the trap luminescence causes apparent spectral narrowing substantial increase of the PLQY. The etching and exchange reactions produce metal fluoride complexes that can adsorb to the QD surface and passivate the chalcogenide/pnictide ions, preventing hole trapping while the absorption of fluoride to the metal centers helps to eliminate electron trapping sites. The high electronegativity of the fluorine atom and the small ionic radius can lead to high adsorption affinities. Moreover, the high electronegativity can reduce the redox potential of the band edges and minimize the reduction potency of photoexcited charges, and reduce the stability of positive trions, which are known to have low PLQY. This interpretation suggests this kind of passivation can prove valuable for applications where redox stability is essential to performance including solid state lighting, and electroluminescence.

As those skilled in the art will appreciate, numerous modifications and variations of the present disclosure are possible in light of these teachings, and all such are contemplated hereby. For example, in addition to the embodiments described herein, the disclosure contemplates and claims embodiments resulting from the combination of features of the disclosure and those of the cited prior art references which complement the features of the present disclosure. Similarly, it will be appreciated that any described material, feature, or article can be used in combination with any other material, feature, or article, and such combinations are considered within the scope of this disclosure.

The disclosures of each patent, patent application, and publication cited or described in this document and the references cited therein are hereby incorporated herein by reference, each in its entirety, for all purposes.

What is claimed is:

1. A process for preparing etched quantum dots comprising Group III-V or Group II-VI elements, comprising:
etching Group III-V or Group II-VI element quantum dots with an organic fluoride agent or with an ammonium fluoride salt and optionally shelling the etched quantum dots.

2. A process for generating light from quantum dots comprising Group III-V or Group II-VI elements, comprising:
etching Group III-V or Group II-VI element quantum dots with an organic fluoride agent or with an ammonium salt to form etched quantum dots;
optionally shelling the etched quantum dots; and
applying energy to the etched quantum dots to provide excited quantum dots.

3. The process of claim 1, wherein the etched quantum dot comprises a core that is X—Y, wherein X is a Group II element such as zinc (Zn), cadmium (Cd), or mercury (Hg), and Y is a Group VI element such as oxygen (O), sulfur (S), selenium (Se), or tellurium (Te).

4. The process of claim 3, wherein the etched quantum dot further comprises one or more shells, such as one shell, or two shells, or three shells, or four or more shells, optionally wherein the shells are the same as one another, or optionally wherein the shells differ from one another.

5. The process of claim 4, wherein the etch quantum dot comprises a first shell that is A′-B′ or A′-C′-B′, wherein A′ and C′ differ and are, independently, A′ is a Group 3 element such as Al, Ga, or In and B′ is a Group 5 element such as N, P, As, or Sb, optionally wherein A′-B′ is GaP, InP, GaAs, InAs, or AlP.

6. The process of claim 4, wherein the etched quantum dot comprises a first shell that is M-Q or M-P-Q, wherein M and P differ and are, independently, Group II element such as Zn, Cd, or Hg and Q is a Group VI element such as O, S, Se, or Te.

7. The process of claim 4, wherein a second shell, third shell, or more is F′-G′, wherein F′ is a Group 3 element such as Al, Ga, or In, and G′ is a Group 5 element such as N, P, As, or Sb, optionally wherein the quantum dot contains two shells that are InP and GaP (InP/GaP) or InAs and GaAs (InAs/GaAs).

8. The process of claim 4, wherein a second shell, third shell, or more shells that is C′D′E′ or C′₁₋ₓD′ₓE′, wherein C′ is a Group 3 element such as Al, Ga, or In, D′ is a Group 3 element such as Al, Ga, or In, E′ is a Group 5 element such as N, P, As, or Sb, and x is 0.01 to 0.99, or optionally C′D′E′ is InGaP, or optionally C′₁₋ₓD′ₓE′ is In₁₋ₓGaₓP or In In₁₋ₓGaₓAs.

9. The process of claim 1, wherein the etched quantum dot comprises a core that is A′-B′, wherein A′ is a Group III element such as indium (In), gallium (Ga), or aluminum (Al), and B′ is a Group V element such as nitrogen (N), phosphorus (P), arsenic (As), or antimony (Sb), optionally wherein A′-B′ is GaP, InP, GaAs, InAs, or AlP.

10. The process of claim 9, wherein the etched quantum dot further comprises one or more shells, such as one shell, or two shells, or three shells, or four or more shells, optionally wherein the shells are the same as one another, or optionally wherein the shells differ from one another.

11. The process of claim 10, wherein the etched quantum dot comprises a first shell that is A″-B″ or A″-C″-B″, wherein A″ and C″ differ and are, independently, a Group III element such as In, Ga, or Al, and B″ is a Group V element such as N, P, As, Sb, provided that A′-B′ and A″-B″ are not the same, optionally wherein A″-B″ is GaP, InP, InS, GaAs, InAs, AlP, or InGaP.

12. The process of claim 10, wherein the etched quantum dot comprises a first shell that is X′—Y′, wherein X′ is a Group 12 metal such as Zn, Cd, or Hg, and Y′ is a Group 6 element such as O, S, Se, or Te, or optionally wherein X′—Y is ZnO, ZnS, ZnSe, CdS, CdSe, CdTe, HgS, HgSe, or HgTe, or such as ZnS or ZnSe.

13. The process of claim 10, wherein a second shell, third shell, or more is X″—Y″, wherein X″ is a Group 12 metal such as Zn, Cd, or Hg, and Y″ is a Group 6 element such as O, S, Se, or Te, provided that X′—Y′ and X″—Y″ are not the same.

14. The process of claim 10, wherein a second shell, third shell, or more shells is P′Q′R′ or P′₁₋ₓQ′ₓR′, wherein P′ is a Group 12 metal such as Zn, Cd, or Hg, Q′ is a Group 12 metal such as Zn, Cd, or Hg, E′ is a Group 6 element such as O, S, Se, or Te, and x is 0.01 to 0.99.

15. The process of claim 1, wherein the organic fluoride agent is an electrophilic fluoride agent.

16. The process of claim 15, wherein the electrophilic fluoride agent is N-fluorobenzenesulfonimide, an N-fluoropyridinium compound, 1-chloromethyl-4-fluoro-1,4-diazoniabicyclo[2.2.2]octane bis(tetrafluoroborate) (Selectfluor), or a 1-chloromethyl-4-fluoro-1,4-diazoniabicyclo[2.2.2]octane bis(tetrafluoroborate derivative.

17. The process of claim 16, wherein the N-fluoropyridinium compound is of formula I: 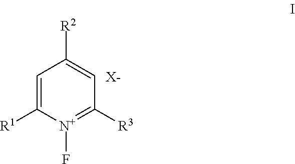
wherein:
R¹, R², and R³ are, independently, halo or C₁₋₆alkyl; and
X⁻ is ⁻BF₄, ⁻OTf, ⁻PF₆, or ⁻NO₃.

18. The process of claim 1, wherein the organic fluoride agent is a nucleophilic fluoride agent.

19. The process of claim 18, wherein the nucleophilic fluoride agent is a sulfonyl fluoride compound, acyl fluoride, tetrahydro-1,3-dimethyl-2(1H)-pyrimidinone hydrofluoride (DMPU-HF), or triethylamine trihydrofluoride (TREAT-HF).

20. The process of claim 19, wherein the sulfonyl fluoride compound is of formula IIA or IIB: 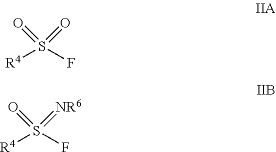
wherein:
R¹ is H, optionally substituted C₁₋₆alkyl, optionally substituted C₂₋₆alkenyl optionally substituted heteroaryl, or optionally substituted aryl; and
R⁶ is H or C₁₋₆alkyl.

21. The process of claim 20, wherein the sulfonyl fluoride is pyridine-2-sulfonyl fluoride (PyFluor), ethenesulfonyl fluoride, benzylsulfonyl fluoride, 4-methylbromosulfonyl fluoride, 4-tolyl-sulfonyl fluoride.

22. The process of claim 19, wherein the acyl fluoride is of formula III: 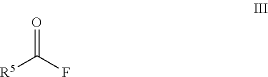
wherein, R⁵ is C₁₋₆alkyl, aryl, or heteroaryl.

23. The process of claim 22, wherein the acyl fluoride is benzoyl fluoride.

24. The process of claim 1, wherein the fluoride agent is:

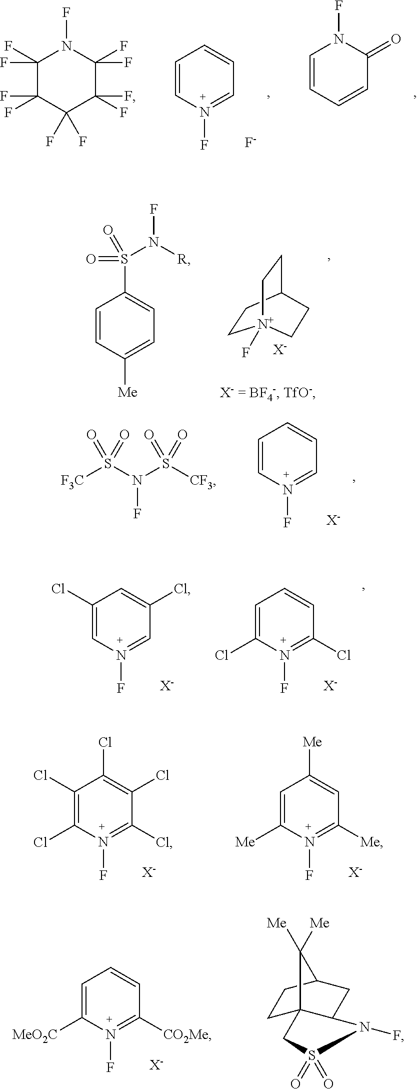

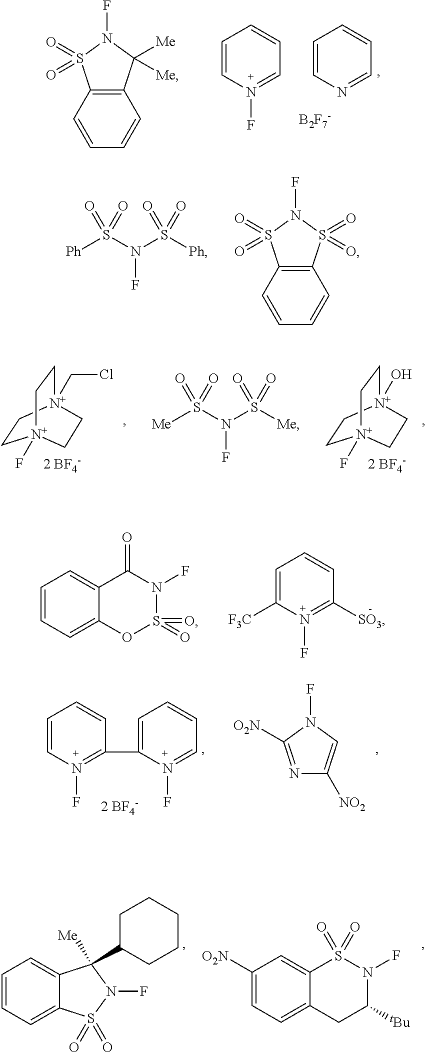

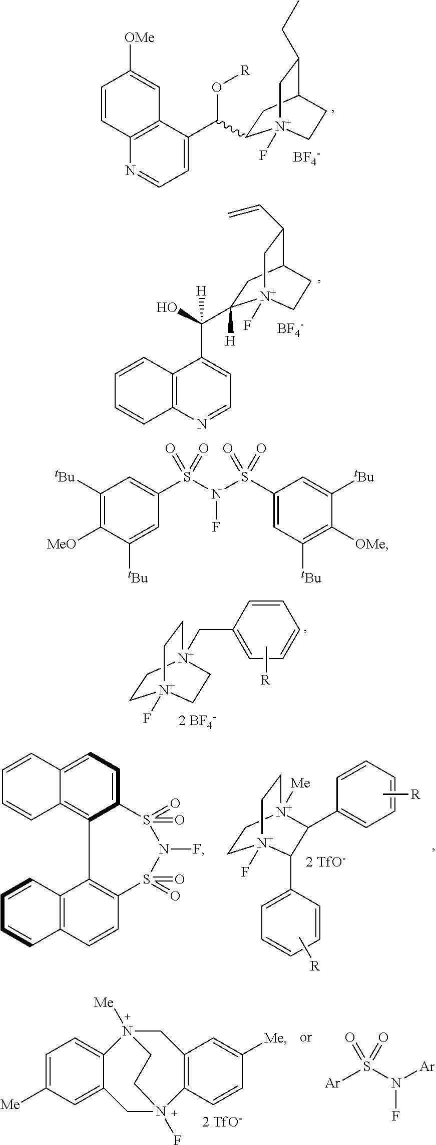

25. The process of claim 1, wherein the ammonium fluoride salt is an organic ammonium fluoride salt.

26. The process of claim 25, wherein the organic ammonium fluoride salt is [NHR¹⁰R¹¹R¹²]F, R¹³F, or [NHR¹⁰R¹¹R¹²][HF₂], wherein R¹⁰, R¹¹, and R¹² are, independently, H, optionally substituted C₁₋₂₀alkyl, optionally substituted C₁₋₂₀alkenyl, optionally substituted C₁₋₂₀alkynyl, optionally substituted C₃₋₁₀cycloalkyl, or optionally substituted aryl; and R¹³ is an optionally substituted N-containing heterocyclyl or optionally substituted N-containing heteroaryl.

27. The process of claim 26, wherein the organic ammonium fluoride salt is triethylammonium fluoride, oleylammonium fluoride, pyridinium fluoride, oleylammonium bifluoride, combinations thereof.

28. The process of claim 1, that is performed in the absence of water, oxygen, or a combination thereof.

29. A quantum dot prepared according to the process of claim 1.

30. The quantum dot of claim 29, that is fluorinated.

31. A device, stain, or label comprising the quantum dot of claim 29.
